(19) United States
(12) Patent Application Publication
(10) Pub. No.: US 2025/0225695 A1
(43) Pub. Date: Jul. 10, 2025

(54) EFFICIENT GENERATION OF HEAT MAPS TO PRESENT AND NAVIGATE DATA

(71) Applicant: Tignis, Inc., Seattle, WA (US)

(72) Inventor: Adam Ashenfelter, Albany, OR (US)

(73) Assignee: Tignis, Inc., Seattle, WA (US)

(21) Appl. No.: 19/013,926

(22) Filed: Jan. 8, 2025

Related U.S. Application Data
(60) Provisional application No. 63/619,656, filed on Jan. 10, 2024.

(51) Int. Cl. G06T 11/20; G06T 11/00

(52) U.S. Cl. CPC G06T 11/206; G06T 11/001

(57) ABSTRACT

In some embodiments, a system is provided that includes a data store, a server computing system, and a browser computing system. The data store is configured to store data records. The server computing system is configured to receive a query from the browser computing system for information from data records between a start time and an end time; retrieve the data records from the data store; generate a plurality of matrices representing the information from the data records, where each matrix of the plurality of matrices is associated with a time bin; and transmit the plurality of matrices to the browser computing system. The browser computing system is configured to generate a tree of matrices, wherein parent matrices of the tree combine values from the matrices of the plurality of matrices, and present a heat map using the tree.

### CROSS-REFERENCE(S) TO RELATED APPLICATION(S)

This application claims the benefit of Provisional Application No. 63/619,656, filed Jan. 10, 2024, the entire disclosure of which is hereby incorporated by reference herein for all purposes.

### BACKGROUND

In semiconductor manufacturing, the continued advancement of devices has become a foundation of our technology-centric modern world. As node sizes continue to shrink to below what was previously thought imaginable, increasing demands are placed on the size of the acceptable output space for each process step in the semiconductor manufacturing process. Any step output parameter, including but not limited to thin film thickness, feature critical dimension size, or overlay magnitude, is increasingly subject to a tighter tolerance on the precise metric. Thus, when specific wafers or devices fail to meet these tight metrics, increased costs are realized due to higher scrap and rework rates, as well as a longer time to get a new process step in acceptable control to begin high volume production.

To address these concerns, instrumentation is applied to numerous portions of the manufacturing process. Trace information is collected from numerous sensors during the manufacturing process, and is stored for use by process engineers to control and improve the overall process. In addition to trace information, metrology information is also collected from the output wafers to detect departures from desired output parameters or other errors.

As the amount of trace and metrology information collected both increase, it becomes exceedingly difficult for process engineers to inspect the information to find patterns that can aid in analysis. What is desired are techniques and systems that are capable of efficiently processing and presenting massive amounts of trace and/or metrology information in ways that are useful for process engineers to browse interactively.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In some embodiments, a computer-implemented method of presenting information from a plurality of data records is provided. A computing system receives a plurality of matrices. Each matrix of the plurality of matrices is associated with a time bin indicating a start time and an end time for data within the matrix. Each matrix of the plurality of matrices includes a first dimension that represents a plurality of first dimension bins and a second dimension that represents a plurality of second dimension bins, and each cell of each matrix of the plurality of matrices indicates a count of data records from the time bin of the matrix that have a value in an associated first dimension bin and an associated second dimension bin. The computing system creates a tree of matrices, wherein the matrices of the plurality of matrices are leaf matrices of the tree and are ordered according to their associated time bins. Creating the tree of matrices includes summing adjacent matrices to create parent matrices that represent multiple time bins, such that a root matrix of the tree of matrices includes information for all of the time bins. The computing system presents a heat map based on the root matrix of the tree of matrices. In some embodiments, a non-transitory computer-readable medium having computer-executable instructions stored thereon is provided. The instructions, in response to execution by one or more processors of a computing system, cause the computing system to perform a method as described above. In some embodiments, a computing system configured to perform a method as described above is provided. Other technical features may be readily apparent to one skilled in the art from the following figures, descriptions, and claims.

In some embodiments, a computer-implemented method of presenting information from a plurality of data records collected between a start time and an end time is provided. A computing system determines a plurality of time bins based on the start time and the end time. For each time bin, the computing system initializes a matrix to be associated with the time bin. The matrix includes a first dimension that represents a plurality of first dimension bins and a second dimension that represents a plurality of second dimension bins, and each cell of the matrix indicates a count of data records from the time bin of the matrix that have an value in an associated first dimension bin and an associated second dimension bin. For each time bin, the computing system determines a set of data records of the plurality of data records that are associated with the time bin. For each data record in the set of data records determined for each time bin, the computing system determines, for each data point in the data record a first dimension bin and a second dimension bin for the data point, and increments the count of the cell in the matrix associated with the first dimension bin and the second dimension bin. The computing system transmits the matrices associated with the plurality of time bins to an interface for generating a heat map based on the matrices. In some embodiments, a non-transitory computer-readable medium having computer-executable instructions stored thereon is provided. The instructions, in response to execution by one or more processors of a computing system, cause the computing system to perform a method as described above. In some embodiments, a computing system configured to perform a method as described above is provided. Other technical features may be readily apparent to one skilled in the art from the following figures, descriptions, and claims.

In some embodiments, a system is provided that includes a data store, a server computing system, and a browser computing system. The data store is configured to store data records. The server computing system is configured to receive a query from the browser computing system for information from data records between a start time and an end time; retrieve the data records from the data store; generate a plurality of matrices representing the information from the data records, where each matrix of the plurality of matrices is associated with a time bin; and transmit the plurality of matrices to the browser computing system. The browser computing system is configured to generate a tree of matrices, wherein parent matrices of the tree combine values from the matrices of the plurality of matrices, and present a heat map using the tree. Other technical features may be readily apparent to one skilled in the art from the following figures, descriptions, and claims.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a high-level schematic illustration of a system in which a data management computing system is used to collect information related to a manufacturing process, and a heat map presentation computing system is used to efficiently present summaries of data extracted from the manufacturing process, according to various aspects of the present disclosure.

FIG. 2 illustrates two non-limiting examples of time series data that could be generated by the manufacturing system and reported to the data management computing system, according to various aspects of the present disclosure.

FIG. 3 illustrates various non-limiting examples of metrology data that could be generated by the metrology system and reported to the data management computing system, according to various aspects of the present disclosure.

FIG. 4 illustrates a non-limiting example embodiment of an interface for presenting a heat map, according to various aspects of the present disclosure.

FIG. 5A and FIG. 5B illustrate a non-limiting example of matrices that can be used to generate heat maps for the time-series data records illustrated in FIG. 2.

FIG. 6A and FIG. 6B illustrate a non-limiting example of different settings of the density selector interface element for the same set of data, according to various aspects of the present disclosure.

FIG. 7 is a chart that illustrates a non-limiting example of brightness values for various density values for various selected values of Z.

FIG. 8A and FIG. 8B illustrate a non-limiting example of a result of interactions with the time slider interface element, according to various aspects of the present disclosure.

FIG. 9 is a block diagram that illustrates aspects of a non-limiting example embodiment of a data management computing system according to various aspects of the present disclosure.

FIG. 10A-FIG. 10C are a flowchart that illustrate a non-limiting example embodiment of a method of optimizing storage of data for generating heat maps according to various aspects of the present disclosure.

FIG. 11 is a block diagram that illustrates aspects of a non-limiting example embodiment of a heat map presentation computing system according to various aspects of the present disclosure.

FIG. 12A-FIG. 12B are a flowchart that illustrates a non-limiting example embodiment of a method of presenting a heat map interface using efficient data structures to improve responsiveness, according to various aspects of the present disclosure.

FIG. 13A and FIG. 13B illustrate a non-limiting example of the construction of a tree of matrices as described at block 1206 and block 1208 of FIG. 12A.

FIG. 14 illustrates an example of determining a subtree of matrices and adding the counts of the matrices within the subtree of matrices for the tree of matrices illustrated in FIG. 13A and FIG. 13B.

### DETAILED DESCRIPTION

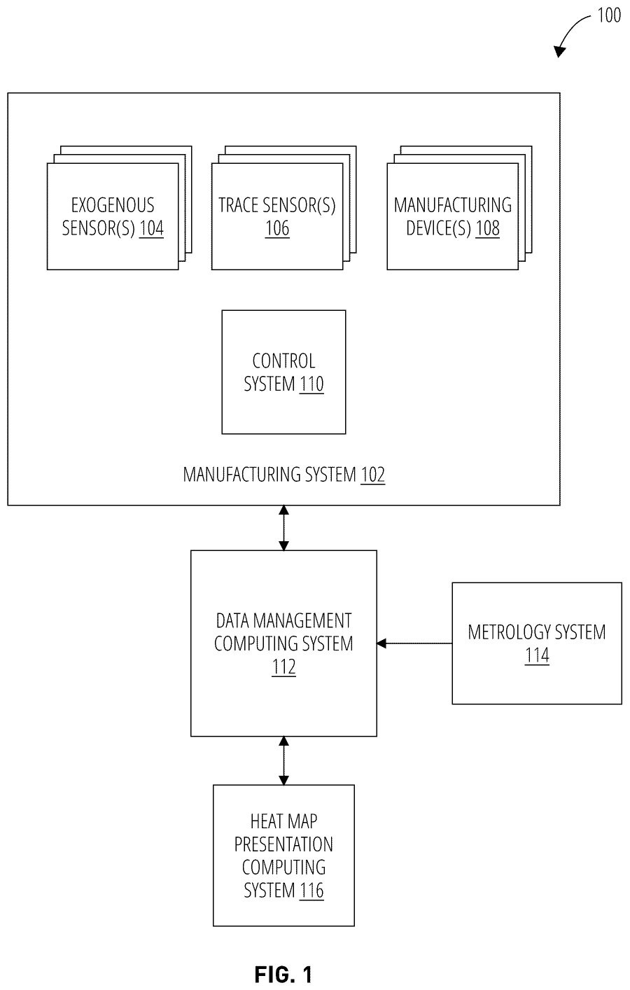

FIG. 1 is a high-level schematic illustration of a system in which a data management computing system is used to collect information related to a manufacturing process, and a heat map presentation computing system is used to efficiently present summaries of data extracted from the manufacturing process, according to various aspects of the present disclosure. As shown, the system 100 includes a manufacturing system 102, a data management computing system 112, a heat map presentation computing system 116, and a metrology system 114.

In some embodiments, the manufacturing system 102 may be any system or collection of sub-systems that perform a manufacturing process, such as a semiconductor manufacturing process. The manufacturing system 102 includes one or more manufacturing devices 108 that perform the physical steps of the manufacturing process, as well as a control system 110 that provides control inputs to the manufacturing devices 108. In a semiconductor manufacturing process, some examples of manufacturing devices 108 may include, but are not limited to, a thin film deposition device, a photolithography device, an etching device, an overlay correction device, and a chemical mechanical planarization device. Some examples of semiconductor manufacturing process steps performed by such devices include, but are not limited to, thin film deposition, photolithography, etching, overlay correction, and chemical mechanical planarization.

During operation of the manufacturing devices 108, one or more exogenous sensors 104 and one or more trace sensors 106 generate data that may be transmitted to and consumed by the data management computing system 112. In some embodiments, the trace sensors 106 may include one or more sensors that measure characteristics of a manufacturing device 108 or an action performed by a manufacturing device 108. Examples of characteristics measured by trace sensors 106 include, but are not limited to, one or more of heating element zone temperatures; mass flow rates of inlet and/or exhaust gas streams; chamber pressures; power supply currents, voltages, powers, and/or frequencies; or optical emission spectroscopy wavelength bands of exhaust streams. In some embodiments, the exogenous sensors 104 may include one or more sensors that measure characteristics of the environment in which the manufacturing devices 108 are operating that may affect the condition of an output of the manufacturing devices 108 for one reason or another. Examples of characteristics that may be measured by the exogenous sensor 104 include, but are not limited to, one or more of a timestamp of an action taken by a manufacturing device 108, an ambient temperature, or a relative humidity. In some embodiments, apriori values may also be collected and reported by the exogenous sensors 104 and/or the trace sensors 106. Examples of apriori values may include, but are not limited to, one or more of a wafer number, a chamber accumulation counter value, a hot plate identifier, and a measurement value from a previous process step.

Once the manufacturing devices 108 perform one or more steps on an input (e.g., a wafer), the metrology system 114 may measure an output of the manufacturing devices 108 (e.g., an output wafer) to analyze the accuracy of the operations performed by the manufacturing devices 108. The metrology system 114 may generate one or more measured metrology values based on the output, including but not limited to one or more of a thickness, a stress, a refractive index, a sidewall angle, and an etch critical dimension. In some embodiments, the metrology system 114 may generate values that represent locations of errors in the output. The measured metrology values may then be provided to the data management computing system 112 for review in order to detect locations on the output associated with defects.

Once the data management computing system 112 has received sensor data and/or metrology data, the data management computing system 112 organizes the data into a format that summarizes the data for various time bins. The heat map presentation computing system 116 retrieves the organized data from the data management computing system 112 and generates presentations of the summarized data that may be efficiently navigated and filtered by time bin. Further details of the efficient generation and presentation of these interfaces are provided below.

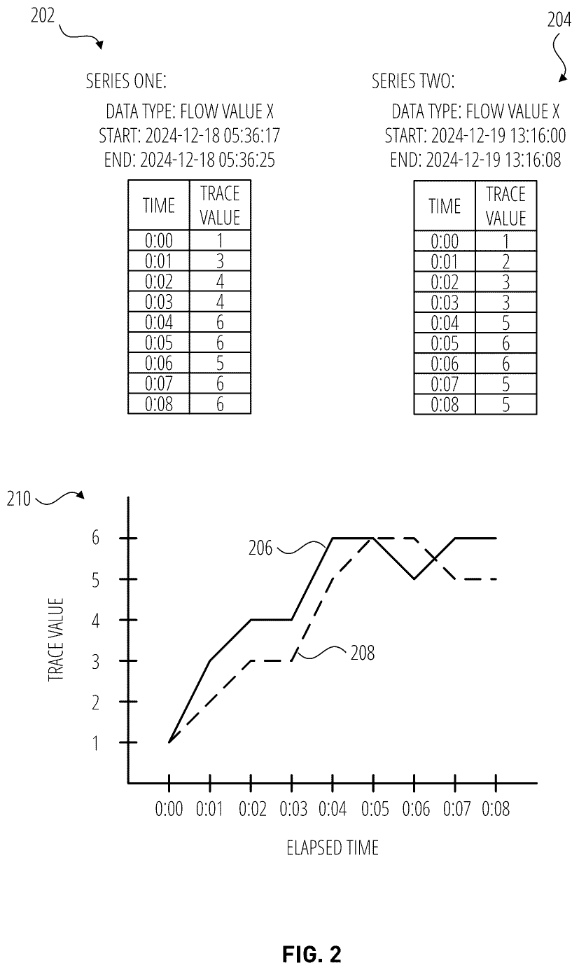

FIG. 2 illustrates two non-limiting examples of time series data that could be generated by the manufacturing system 102 and reported to the data management computing system 112, according to various aspects of the present disclosure. The time-series data records are each associated with a data type, a start time, and an end time. The data type indicates what type of information is stored in the values of the time-series data record (e.g., what trace sensor 106, exogenous sensor 104, or other data source generated the values of the time-series data record). The start time and end time indicate when the values of the time-series data record were generated. Each time-series data record also includes a set of time-value pairs that indicates values generated by the sensor and the times at which the values were generated. In some embodiments, the times of the time-value pairs are provided as relative elapsed times since the start of the time-series data record as opposed to absolute time stamps in order to facilitate comparison of time-series data records for matching data types. In other embodiments, the times of the time-value pairs may be provided as absolute time stamps, and elapsed times may be computed from the time stamps.

As shown, the first time series 202 and the second time series 204 are provided as non-limiting examples of time-series data records generated by a trace sensor 106 associated with a “flow value X” value (e.g., trace values generated by a specific flow sensor device). The first time series 202 has a start time of Dec. 18, 2024, at 05:36:17, and the second time series 204 has a start time of Dec. 19, 2024, at 13:16:00. Each of the first time series 202 and the second time series 204 proceed for 8 seconds, thereby generating 9 time-value pairs.

In some embodiments, all of the illustrated elements (the data type, the start time, the end time, and the time-value pairs) may be present in a time-series data record. In some embodiments, some of the illustrated elements that can be implied from other elements may be omitted from the time-series data record itself. For example, in some embodiments the start time or end time may be omitted, and the missing value may be implied from the value that is present. As another example, in some embodiments the time portion of the time-value pairs may be omitted if the values are generated at a known frequency, such that the time values may be implied with reference to the start time and the known frequency.

To visualize the first time series 202 and the second time series 204, FIG. 2 includes a chart 210 having a first time series plot 206 of the time-value pairs of the first time series 202, and a second time series plot 208 of the time-value pairs of the second time series 204. In the chart 210, the elapsed time is illustrated on the x-axis (a first dimension), and the trace values are illustrated on the y-axis (a second dimension). Overlaying plots of time series data is a common way of comparing time-series data records to each other, but quickly becomes difficult to interpret as the number of time-series data records increases and the number of time-value pairs in each time-series data record increases as well.

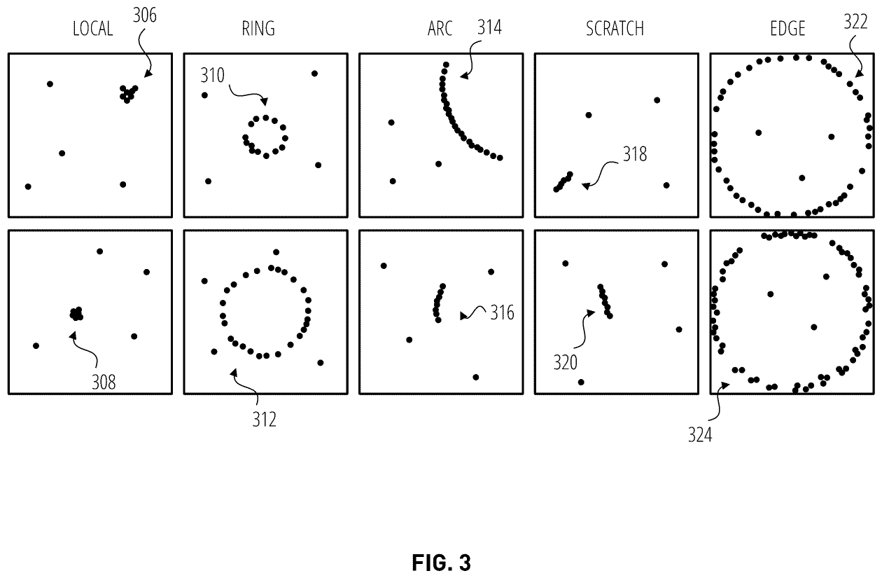

FIG. 3 illustrates various non-limiting examples of metrology data that could be generated by the metrology system 114 and reported to the data management computing system 112, according to various aspects of the present disclosure. The examples show the geography of various types of errors detected in metrology data, including a first local error 306 and second local error 308, a first ring error 310 and second ring error 312, a first arc error 314 and second arc error 316, a first scratch error 318 and second scratch error 320, and a first edge error 322 and second edge error 324. Each of the examples illustrated in FIG. 3 may illustrate detected errors in a single run/on a single output wafer, or may illustrate a compilation of detected errors across multiple runs/multiple output wafers.

Each dot of the illustrated sets of metrology data represents a detected error in the output wafer as determined from the metrology data. Each dot indicates a location in a first dimension and a second dimension (e.g., an x-location and a y-location in a coordinate plane) at which the corresponding detected error was found. By characterizing the pattern of the errors as local, ring, arc, scratch, edge, or other shapes, a process engineer has a starting point for a root cause analysis for the errors, as various steps of the manufacturing process may be known to contribute to characteristic error patterns.

When conducting root-cause analysis, a process engineer may want to visualize a set of time-series data records (traces) or sets of metrology errors overlaid on each other, and potentially filtered by context such as sensor, module, recipe, step, lot, etc. If the set of time-series data records is small, the records can be visualized with a line chart or a scatter plot as shown in FIG. 2. However, as the number of traces increases, those approaches become cluttered and lose their effectiveness. Likewise, compiling detected metrology errors from multiple runs prior to display as shown in FIG. 3 is desirable during root-cause analysis, particularly if the errors are relatively rare. Two-dimensional histograms, also referred to as heat maps, are an effective way to present large composed sets of data records such as time-series data records or metrology records. In some embodiments of the present disclosure, heat maps are used to visualize combined sets of data records.

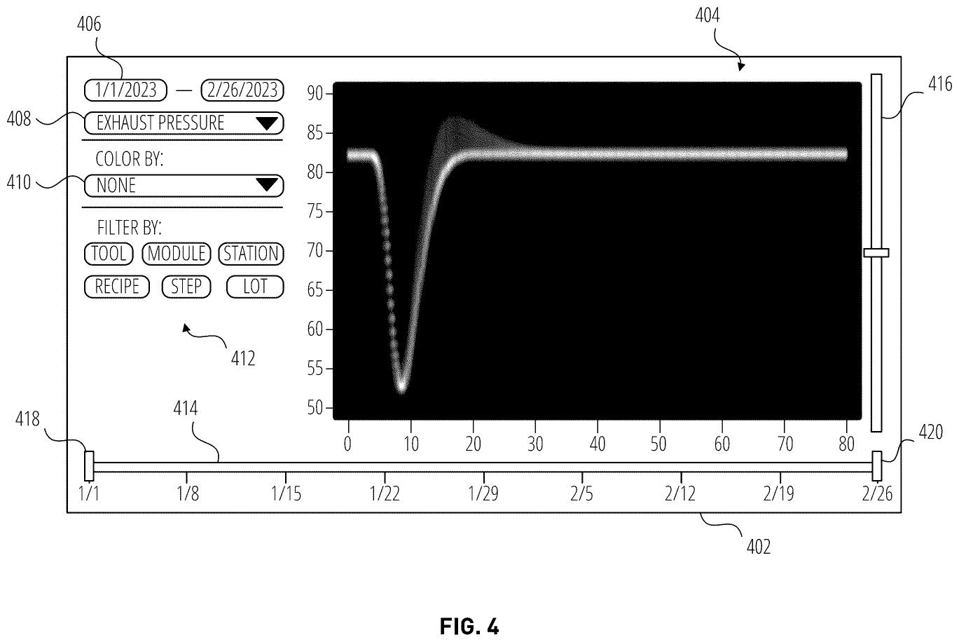

FIG. 4 illustrates a non-limiting example embodiment of an interface for presenting a heat map, according to various aspects of the present disclosure. In the heat map interface 402, a user may use a time selector interface element 406 to select a start time and an end time between which data should be displayed. Additional interface elements allow a user to further refine the data to be displayed, such as by using a data type selector interface element 408 to select a type of data to be displayed (e.g., time-series data records representing a specific type of value generated by sensors of the manufacturing system 102; metrology data records representing a specific type of error; etc.), using a color selector interface element 410 to assign a color to the pixels in the heat map for the data type, and using a filter interface element 412 to further limit the data of the selected data type.

Once the data records are retrieved and placed in a format suitable for the generation of the interface, a heat map 404 is displayed. In the heat map 404, a first dimension extends horizontally, and a second dimension extends vertically. Depending on the data type, the first dimension and second dimension may represent different types of values. For time-series data records, the first dimension may represent the time values of the time-value pairs in the time-series data record (e.g., a process time in seconds, an elapsed time relative to the beginning of the time-series data record, etc.), and the second dimension may represent the values of the time-value pairs. For metrology records, the first dimension may represent a horizontal location on the output wafer at which the error was found and the second dimension may represent a vertical location on the output wafer at which the error was found. In the illustrated embodiment, the data type is an exhaust pressure detected by a trace sensor 106. The first dimension represents an elapsed time from the start of the time-series data record, and the second dimension represents the exhaust pressure value.

As a two-dimensional histogram, the first dimension is divided into a number of first dimension bins and the second dimension is divided into a number of second dimension bins. The number of bins on either dimension may be determined in any suitable way. Many techniques for automatically choosing the number of bins based on known or theorized characteristics of the data are known, such as square-root choice (k=┌\sqrt{n}┐), Sturges's formula (k=┌log₂n┐+1, which implicitly assumes an approximately normal distribution), or other techniques, wherein k is the number of bins and n is the number of data points in the sample. In some embodiments, the number of bins on either dimension may be adjusted by the user.

Each of the data points in each data record can be considered to be within a cell of the heat map. Specifically, each data point is located within a cell at the intersection of its first dimension and its second dimension. For example, for a time-value pair in a time-series data record, the time-value pair can be considered to be within a cell of the heat map that corresponds to the elapsed time bin at which the time of the time-value pair is located, and the value bin at which the value of the time-value pair is located. Each data point of each data record is added to a cell, with multiple data records being added to the same heat map, and thus adding additional values to the cells.

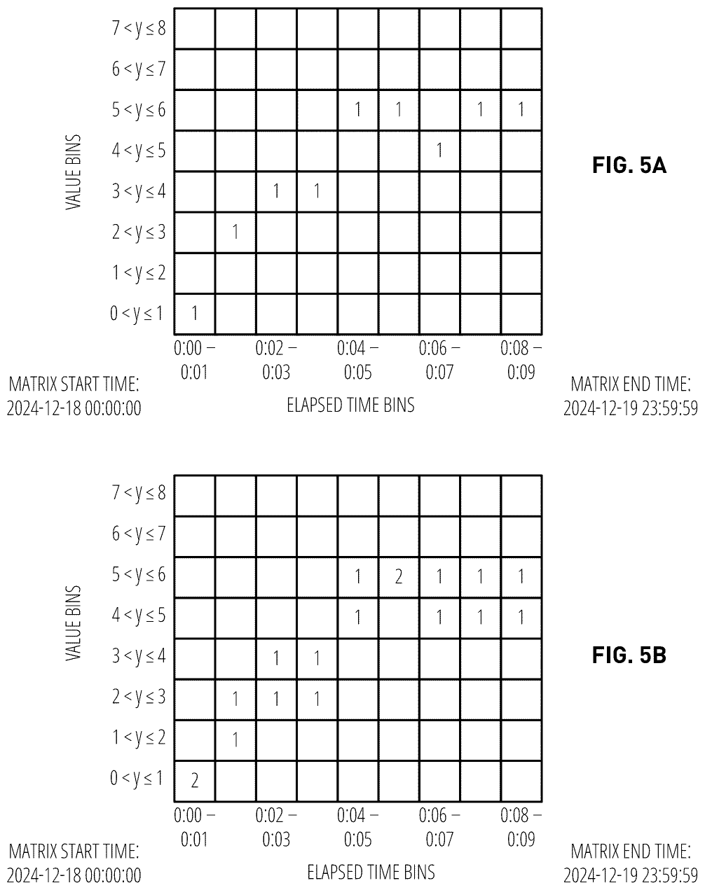

FIG. 5A and FIG. 5B illustrate a non-limiting example of matrices that can be used to generate heat maps for the time-series data records illustrated in FIG. 2. In FIG. 5A and FIG. 5B, a matrix having a plurality of elapsed time bins in a first dimension and a plurality of value bins in a second dimension is shown. FIG. 5A illustrates the state of the matrix after adding the data points for the first time series 202. All blank cells in the matrix may be assumed to have zero values, which are not illustrated to avoid obscuring the other data. Referring back to FIG. 2, the first data point in the first time series 202 had a time of 0:00, and a value of 1. As such, the cell at the intersection of the elapsed time bin for 0:00-0:01 and the value bin for 0<y≤1 is incremented by 1. The second data point in the first time series 202 had a time of 0:01, and a value of 3. Accordingly, the cell at the intersection of the elapsed time bin for 0:01-0:02 and the value bin for 2<y≤3 is incremented by 1. This continues on until each of the data points for the first time series 202 is added to the matrix. FIG. 5B illustrates the further state of the matrix after adding the data points for the second time series 204. As can be seen, the cells for which both time series have values have been incremented to 2 (i.e., the cell for the intersection of the 0:00-0:01 elapsed time bin and the 0<y≤1 value bin, and the cell for the intersection of the 0:04-0:05 elapsed time bin and the 5<y≤6 value bin), other cells for which only one of the time series had a value have been incremented to 1, and other cells have not been incremented. Though the first time series 202 and the second time series 204 separately only have a single value in each cell for the sake of simplicity, one of skill in the art will recognize that in embodiments with real data where the values have high resolution and may be generated at a high frequency, a single time-series data record representing real data may include many data points for a given cell. Further details of the matrix illustrated in FIG. 5A and FIG. 5B will be described below.

Returning to FIG. 4, in the illustrated heat map 404, black (or lower value pixels) is used to represent cells that contain no data points. Brighter colors (or higher value pixels) are used to indicate cells that contain data points, with the brightness of the pixel indicating the number of data points in the cell. From this, a process engineer can quickly determine the cells which are more or less common in the heat map 404.

For some data, the distribution of typical data points (to the exclusion of outliers) may be more useful during analysis. For other data, the presence and location of outlying data points may be more useful during analysis. Using a single scale for the brightness of cells in the heat map 404 may make it difficult to usefully display both kinds of data distributions. To address this issue, some embodiments of the present disclosure may include a density selector interface element 416. The heat map 404 may be considered a representation of density. If a cell has no data points, then it has zero density and is plotted as black (or a lower value pixel). If a cell contains data points, then the density is determined by dividing the count of data points in the cell by the maximum count of data points for a cell in the entire heat map 404. This gives each cell a density value over a range of zero to one. The heat map 404 may then display the density values for the cells using pixels of varying intensities based on the density values.

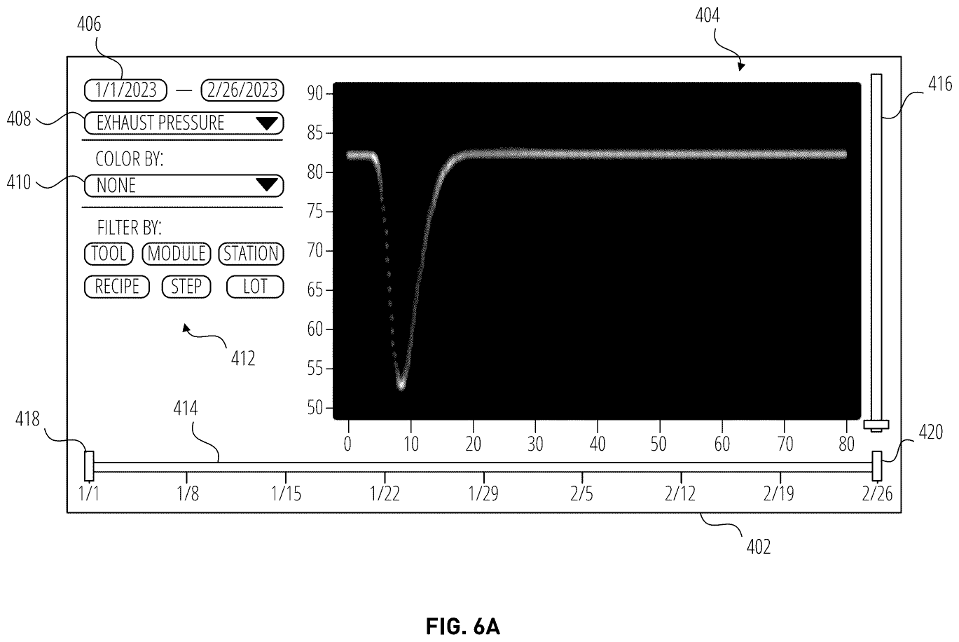

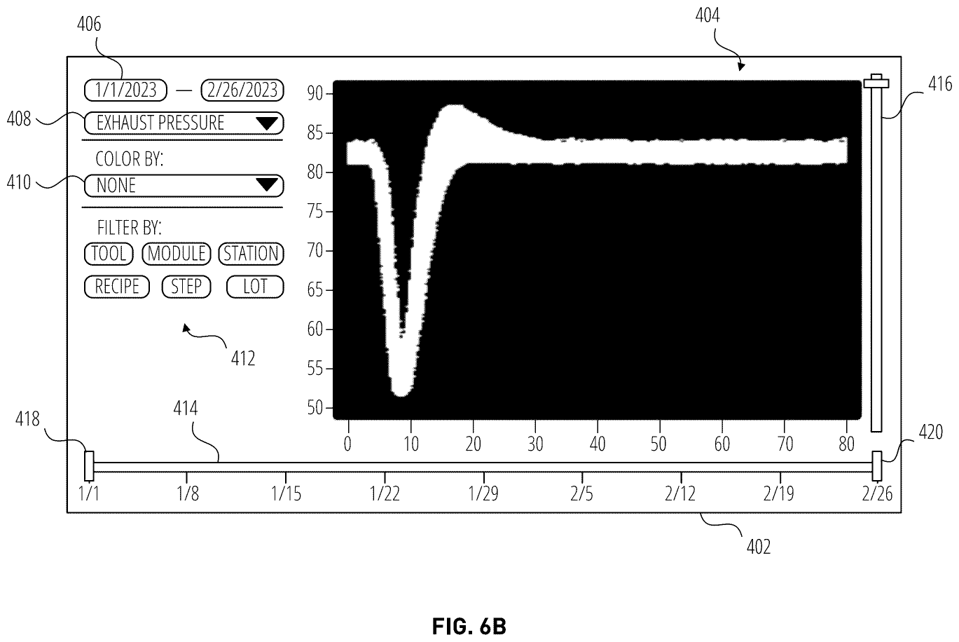

The density selector interface element 416 allows a user to adjust the mapping of density values to color, brightness, or any other suitable characteristic of the pixels. A user may use adjustment to choose a mapping that either highlights or de-emphasizes uncommon (or low-density) cells. The heat map 404 of FIG. 4 illustrates a setting of the density selector interface element 416 in a middle of its range. FIG. 6A and FIG. 6B illustrate a non-limiting example of different settings of the density selector interface element 416 for the same set of data. In FIG. 6A, the density selector interface element 416 is set to a minimal level. Accordingly, the brightness of cells having relatively low density values remains low, and the brightness of cells having relatively high density values is more prominent. This allows the cells with low density values to be hidden, such that the user can appreciate the shape of more common data records. In FIG. 6B, the density selector interface element 416 is set to a maximal level. Accordingly, cells having a zero density value are black, and cells with any non-zero density values are set to a maximum brightness. This allows the full range of the data records to be visualized, and makes outliers easy to detect.

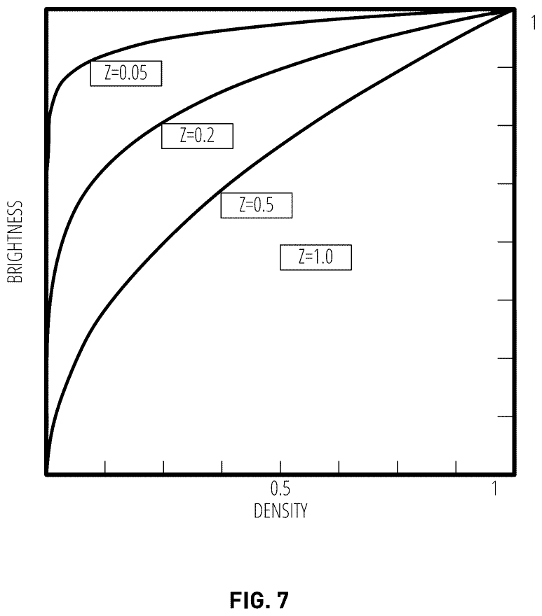

In the illustrated embodiments, the brightness of each cell (in a range from zero to one) is determined as a function of the density value of each cell. Any suitable function may be used. One non-limiting example of a suitable function is:
B=D^{Z}

where B is the brightness value, D is the density value for a cell, and Z is a setting that is adjustable using the density selector interface element 416. The minimal value for the density selector interface element 416 may be Z=1.0, and the maximal value for the density selector interface element 416 may be Z=0 (or a small non-zero value). The default position of the density selector interface element 416 may be the middle, defined as Z=0.5. This gives a good balance allowing a user to clearly see the common trends in the trace but also see outliers. FIG. 7 is a chart that illustrates a non-limiting example of brightness values for various density values for various selected values of Z. A user may be permitted to adjust the density selector interface element 416 in real-time. Since only a single calculation is required to change the brightness for each cell once the density values have been computed, the contrast of the heat map 404 may be updated in real time, allowing users to intuitively adjust the density function appropriate for the displayed data records.

Returning again to FIG. 4, the heat map interface 402 also includes a color selector interface element 410. In some embodiments, the heat map interface 402 may be capable of displaying information from more than one data type at a time. The color selector interface element 410 allows a color to be chosen for the data type identified by the data type selector interface element 408. When a new data type is selected using the data type selector interface element 408, the existing heat map 404 may be updated with information for the new data type, in a different color as selected by the color selector interface element 410. By presenting multiple data types in different colors in the same heat map 404, the user may easily look for correlations between values in the multiple data types. In some embodiments, the color selector interface element 410 may be used to select different colors for different filter data categories selected by the filter interface element 412 for the same data type. For example, a first color may be selected using the color selector interface element 410 for data records of a given data type from a first station of the manufacturing system 102 selected by the filter interface element 412, and a second color may be selected using the color selector interface element 410 for data records of the given data type from a second station of the manufacturing system 102 selected by the filter interface element 412. The brightness for each color may be determined using the density selector interface element 416 as discussed above. In some embodiments, separate density selector interface elements 416 may be provided for each color.

As shown in FIG. 4, the heat map interface 402 also includes a time slider interface element 414. Interacting with the time slider interface element 414 allows the user to adjust the period of time for which data records are displayed in the heat map 404. The time slider interface element 414 has the same range as the time selector interface element 406, in that the earliest time that may be selected in the time slider interface element 414 is the start time of the time selector interface element 406, and the latest time that may be selected in the time slider interface element 414 is the end time of the time selector interface element 406.

The time slider interface element 414 includes a time slider start element 418 that indicates a start time for the data records used to create the heat map 404, and a time slider end element 420 that indicates an end time for the data records used to create the heat map 404. In FIG. 4, the time slider start element 418 is positioned at the earliest possible time and the time slider end element 420 is positioned at the latest possible time, and so the heat map 404 displays all of the data records retrieved according to the time selector interface element 406. However, the user may slide the time slider start element 418, the time slider end element 420, or both together (by dragging the area between the time slider start element 418 and the time slider end element 420), in order to select smaller sets of data records for display. This can be particularly useful when reviewing data records for transient conditions that may not be present during the entire retrieved time period.

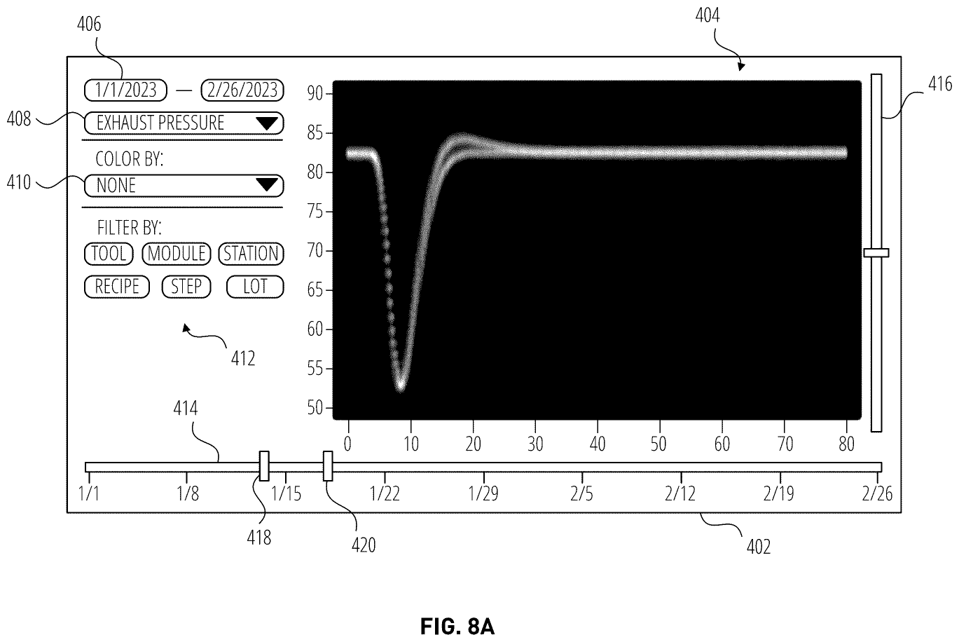

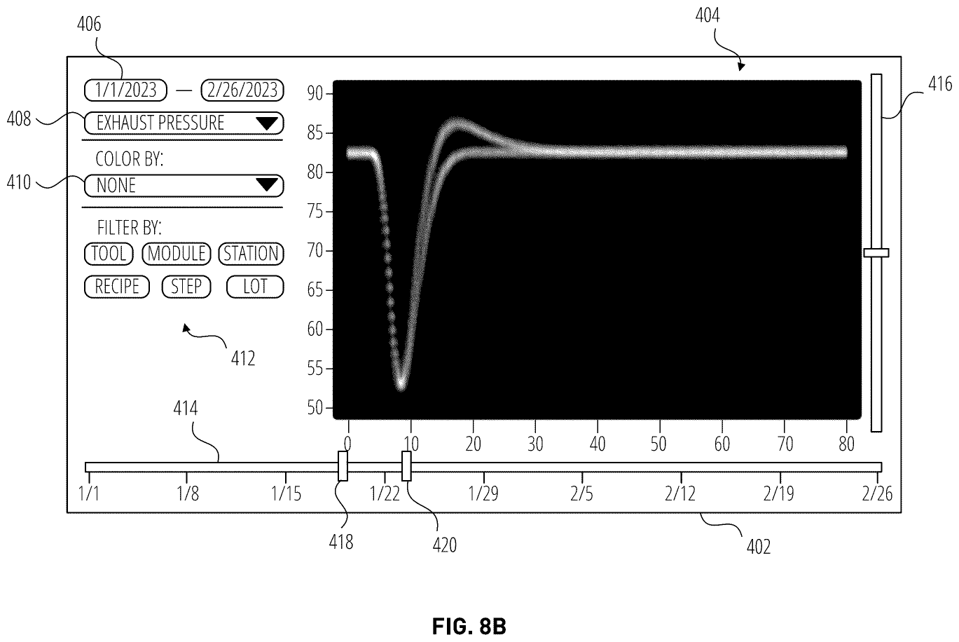

FIG. 8A and FIG. 8B illustrate a non-limiting example of a result of interactions with the time slider interface element 414, according to various aspects of the present disclosure. In FIG. 8A, the time slider start element 418 and the time slider end element 420 have been moved to about four days apart, with the time slider start element 418 being moved to about January 14, and the time slider end element 420 being moved to about January 18. Compared to the presentation of the entirety of the data records shown in FIG. 4, it is easier to see in this subset of the data records that the performance around fifteen seconds into the data records is starting to diverge.

In FIG. 8B, the time slider start element 418 and the time slider end element 420 have been moved about a week later, with the time slider start element 418 moved to about January 19 and the time slider end element 420 moved to about January 23. In some embodiments, this may be accomplished by dragging the portion of the time slider interface element 414 between the time slider start element 418 and the time slider end element 420, such that both the time slider start element 418 and the time slider end element 420 are moved without changing the distance between them. In some embodiments, this may be accomplished by separately moving the time slider start element 418 and the time slider end element 420. It can be seen that the divergence in the data records shown in FIG. 8B is increased in magnitude between January 19 and January 23, compared to the divergence illustrated in FIG. 8A between January 14 and January 18. Using this interface to understand how the data records change over time gives a process engineer insight into what may have led to issues in the manufacturing process.

Typically, a user would use the heat map interface 402 to retrieve a set of data records, to filter the set of data records, and then to interactively browse the data records using the time slider interface element 414 to search for meaningful patterns in the data records. Once the amount of data being processed increases, however, it becomes computationally impractical to generate heat map interfaces that can be updated interactively (i.e., that can allow selection, filtering, and/or navigation of the data set in real time or near-real time), as would be useful in conducting a root cause analysis. In particular, navigating the interface using the time slider interface element 414 can become increasingly difficult, since each movement of the elements of the time slider interface element 414 involves re-computation of each of the cells of the heat map 404 based on the set of data records within the new period of time indicated by the new position of the time slider interface element 414. As the set of data records grows into the thousands or tens of thousands, and as the resolution of the first dimension and second dimension of the heat map 404 also grows, the recalculation of the cells of the heat map 404 becomes increasingly time consuming, such that real-time computation of the heat map 404 in response to interactions with the time slider interface element 414 is no longer possible. Efficient techniques for processing data records for display that enable real-time navigation are desired.

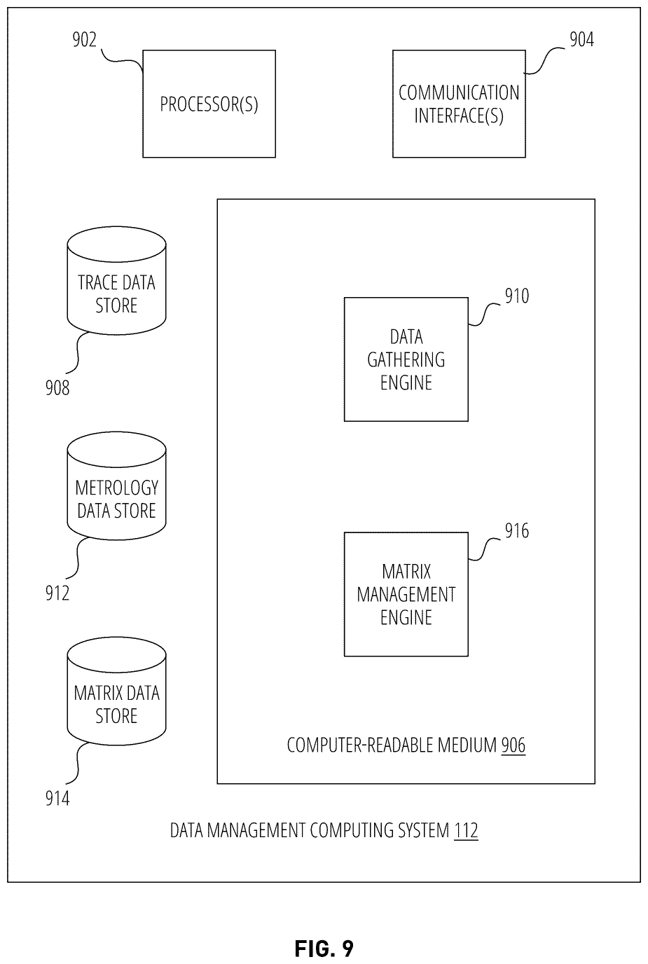

FIG. 9 is a block diagram that illustrates aspects of a non-limiting example embodiment of a data management computing system according to various aspects of the present disclosure. The data management computing system 112, which may be considered a server computing system in some embodiments, is configured to collect information from the manufacturing system 102 and the metrology system 114, and to prepare the information for efficient presentation in heat maps that are reconfigurable in real time. The illustrated data management computing system 112 may be implemented by any computing device or collection of computing devices, including but not limited to a desktop computing device, a laptop computing device, a mobile computing device, a server computing device, a computing device of a cloud computing system, and/or combinations thereof.

As shown, the data management computing system 112 includes one or more processors 902, one or more communication interfaces 904, a trace data store 908, a metrology data store 912, a matrix data store 914, and a computer-readable medium 906.

In some embodiments, the processors 902 may include any suitable type of general-purpose computer processor. In some embodiments, the processors 902 may include one or more special-purpose computer processors or AI accelerators optimized for specific computing tasks, including but not limited to graphical processing units (GPUs), vision processing units (VPUs), and tensor processing units (TPUs).

In some embodiments, the communication interfaces 904 include one or more hardware and or software interfaces suitable for providing communication links between components. The communication interfaces 904 may support one or more wired communication technologies (including but not limited to Ethernet, Fire Wire, and USB), one or more wireless communication technologies (including but not limited to Wi-Fi, WiMAX, Bluetooth, 2G, 3G, 4G, 5G, and LTE), and/or combinations thereof.

As shown, the computer-readable medium 906 has stored thereon logic that, in response to execution by the one or more processors 902, cause the data management computing system 112 to provide a data gathering engine 910 and a matrix management engine 916.

As used herein, “computer-readable medium” refers to a removable or nonremovable device that implements any technology capable of storing information in a volatile or non-volatile manner to be read by a processor of a computing device, including but not limited to: a hard drive; a flash memory; a solid state drive; random-access memory (RAM); read-only memory (ROM); a CD-ROM, a DVD, or other disk storage; a magnetic cassette; a magnetic tape; and a magnetic disk storage.

In some embodiments, the data gathering engine 910 is configured to receive time-series data records from trace sensors 106 and exogenous sensors 104, and to store the time-series data records in the trace data store 908. In some embodiments, the data gathering engine 910 may be configured to receive metrology data from the metrology system 114, and to store the metrology data in the metrology data store 912, instead of or in addition to receiving time-series data records from the components of the manufacturing system 102. In some embodiments, the matrix management engine 916 is configured to retrieve time-series data records from the trace data store 908 and/or metrology data from the metrology data store 912, to divide the retrieved data into time bins, and to create matrices that include combined information for the time bins. The metrology data store 912 stores the created matrices in the matrix data store 914, and provides the matrices in response to queries from the heat map presentation computing system 116.

Further description of the configuration of each of these components is provided below.

As used herein, “engine” refers to logic embodied in hardware or software instructions, which can be written in one or more programming languages, including but not limited to C, C++, C#, COBOL, JAVA™, PHP, Perl, HTML, CSS, Javascript, VBScript, ASPX, Go, and Python. An engine may be compiled into executable programs or written in interpreted programming languages. Software engines may be callable from other engines or from themselves. Generally, the engines described herein refer to logical modules that can be merged with other engines, or can be divided into sub-engines. The engines can be implemented by logic stored in any type of computer-readable medium, or computer storage device and be stored on and executed by one or more general purpose computers, thus creating a special purpose computer configured to provide the engine or the functionality thereof. The engines can be implemented by logic programmed into an application-specific integrated circuit (ASIC), a field-programmable gate array (FPGA), or another hardware device.

As used herein, “data store” refers to any suitable device configured to store data for access by a computing device. One example of a data store is a highly reliable, high-speed relational database management system (DBMS) executing on one or more computing devices and accessible over a high-speed network. Another example of a data store is a key-value store. However, any other suitable storage technique and/or device capable of quickly and reliably providing the stored data in response to queries may be used, and the computing device may be accessible locally instead of over a network, or may be provided as a cloud-based service. A data store may also include data stored in an organized manner on a computer-readable storage medium, such as a hard disk drive, a flash memory, RAM, ROM, or any other type of computer-readable storage medium. One of ordinary skill in the art will recognize that separate data stores described herein may be combined into a single data store, and/or a single data store described herein may be separated into multiple data stores, without departing from the scope of the present disclosure.

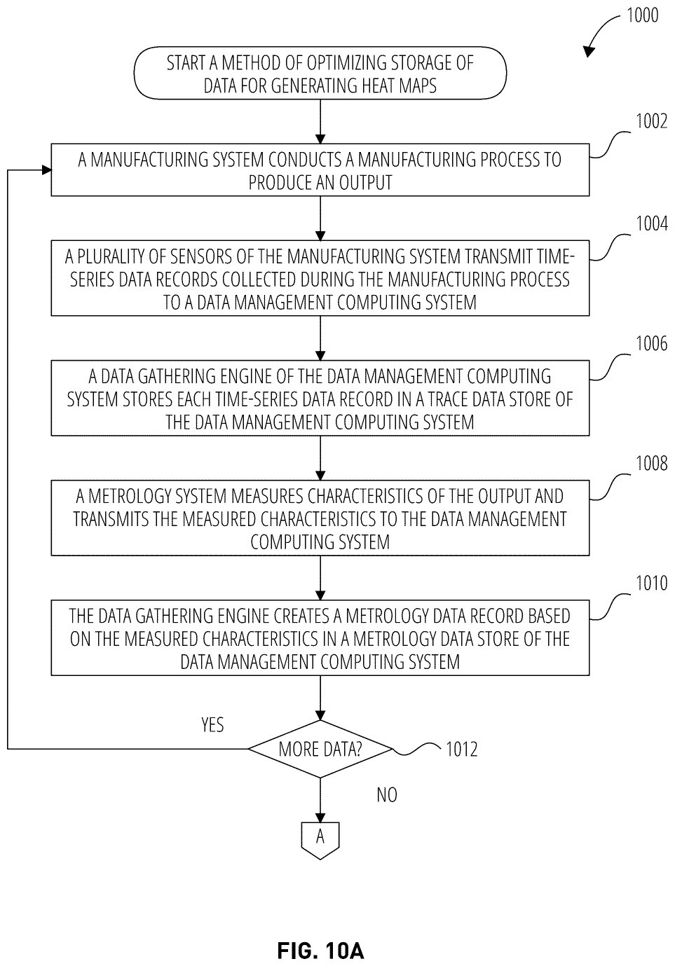

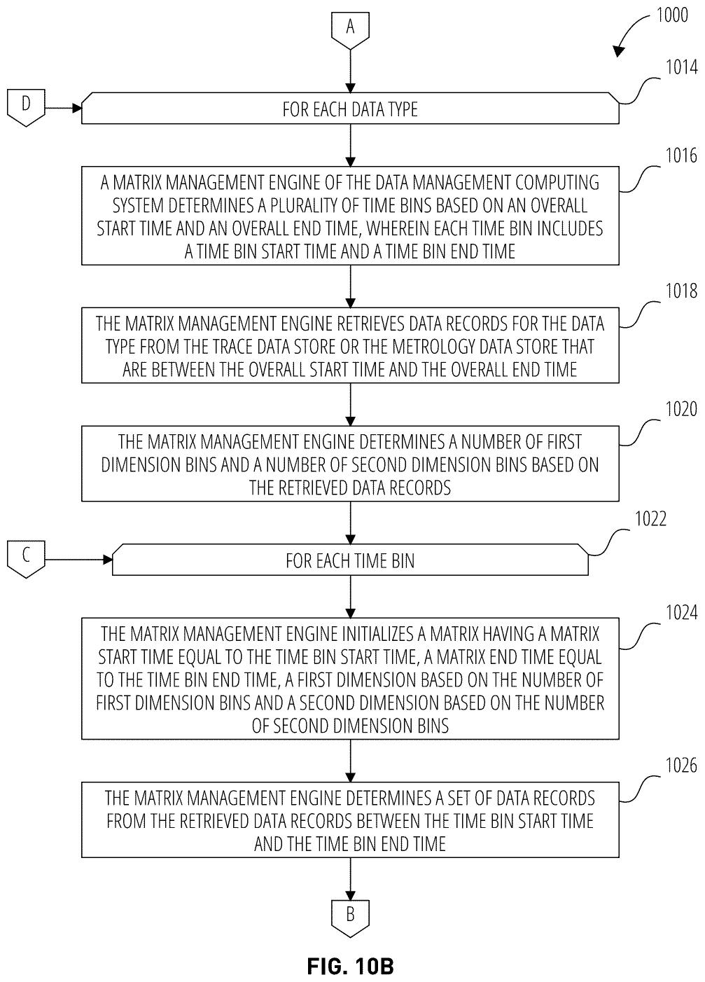

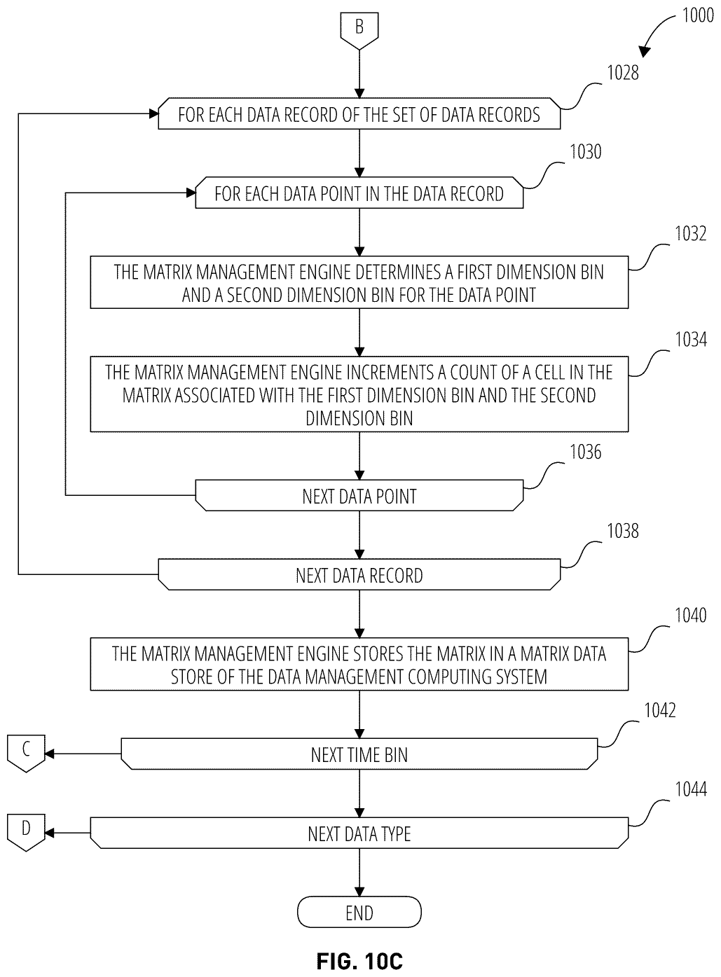

FIG. 10A-FIG. 10C are a flowchart that illustrate a non-limiting example embodiment of a method of optimizing storage of data for generating heat maps according to various aspects of the present disclosure. In the method 1000, the data management computing system 112 compiles information received from the manufacturing system 102 and/or metrology system 114 into matrices that may be used by the heat map presentation computing system 116 to efficiently generate an interactive user interface, as described below in method 1200.

From a start block, the method 1000 proceeds to block 1002, where a manufacturing system 102 conducts a manufacturing process to produce an output. Typically, the manufacturing system 102 is a semiconductor manufacturing system and the output is an output wafer. This embodiment should not be seen as limiting, however, and in other embodiments, other types of manufacturing systems 102 and other types of outputs may be used.

At block 1004, a plurality of sensors of the manufacturing system 102 transmit time-series data records collected during the manufacturing process to a data management computing system 112, and at block 1006, a data gathering engine 910 of the data management computing system 112 stores each time-series data record in a trace data store 908 of the data management computing system 112. In some embodiments, the data gathering engine 910 may store each time-series data record along with metadata such as an identifier of a data type represented by the time-series data record, a start time of the time-series data record, and/or other relevant items of information about the time-series data record.

At block 1008, a metrology system 114 measures characteristics of the output and transmits the measured characteristics to the data management computing system 112, and at block 1010, the data gathering engine 910 creates a metrology data record based on the measured characteristics in a metrology data store 912 of the data management computing system 112. In some embodiments, the data gathering engine 910 may store each metrology data record along with metadata such as a data type represented by the metrology data record, a collection time of the metrology data record, and/or other relevant items of information about the metrology data record. One will recognize that method 1000 is illustrated and described as collecting both types of data records (i.e., time series data records and metrology data records) for the sake of completeness. In some embodiments, one type of data record may be used without the other type of data record.

The method 1000 then proceeds to a decision block 1012, where a determination is made regarding whether the method 1000 should continue to collect more data, or whether the method 1000 should proceed to process the data stored in the metrology data store 912 and trace data store 908. The determination of decision block 1012 may be made for any suitable reason. For example, in some embodiments the method 1000 may advance past decision block 1012 upon receiving a request for data records between a start time and an end time, and may otherwise continue collecting data indefinitely. As another example, in some embodiments the method 1000 may collect data records for a predetermined length of time (e.g., a day, a week, a month, etc.) before proceeding to execute the optimized organization steps of the rest of the method 1000.

If it is determined that the method 1000 should collect more data, then the result of decision block 1012 is YES, and the method 1000 returns to block 1002 to collect more data. Otherwise, if it is determined that the method 1000 does not have more data to collect (or that the method 1000 should proceed to generate matrices in response to a request from the heat map presentation computing system 116), then the result of decision block 1012 is NO, and the method 1000 proceeds to a continuation terminal (“terminal A”).

From terminal A (FIG. 10B), the method 1000 proceeds to a for-loop defined between a for-loop start block 1014 and a for-loop end block 1044, wherein data records between an overall start time and an overall end time that are stored in the trace data store 908 and/or the metrology data store 912 are organized for presentation in navigable heat map interfaces. The overall start time and the overall end time may be specified in a request received from the heat map presentation computing system 116 (e.g., as specified by the time selector interface element 406), may represent the earliest and latest data records in the data stores, or may be determined using any other suitable technique.

In the for-loop defined between the for-loop start block 1014 and the for-loop end block 1044, a single data type of the data records (e.g., data from a specific trace sensor 106 or exogenous sensor 104; a specific type of metrology data; or any other data type) is processed at a time. As such, the for-loop defined between the for-loop start block 1014 and the for-loop end block 1044 may be used to separately process every data type in the data records retrieved from the trace data store 908 and/or the metrology data store 912 between the overall start time and the overall end time.

From the for-loop start block 1014, the method 1000 proceeds to block 1016, where a matrix management engine 916 of the data management computing system 112 determines a plurality of time bins based on an overall start time and an overall end time, wherein each time bin includes a time bin start time and a time bin end time. In some embodiments, the matrix management engine 916 may divide the period of time between the overall start time and the overall end time into a number of time bins based on a target number of time bins that provides a predetermined amount of granularity in adjustment of the time slider interface element 414. In some embodiments, the number of time bins may also be determined such that the size of each time bin provides an integer-sized interval for adjustment. In some embodiments, a number of time bins between 600 and 1000, such as 800 time bins, may be targeted as providing a predetermined amount of granularity, though in other embodiments, other numbers may be used for the target number of time bins. The matrix management engine 916 may determine a time bin size based on an integer number of minutes, hours, days, or other units that results in a number of time bins between the overall start time and the overall end time that is as close as possible to the target number. As a non-limiting example, if the overall start time is January 1st, and the overall end time is February 26 (a duration of 57 days), 684 time bins may be used so that the bucket size for each bucket is two hours.

The time bin start time and the time bin end time indicate the boundaries for data in each time bin. Continuing the non-limiting example above that splits an overall start time of January 1st and an overall end time of February 26 into 684 time bins, the first time bin would have a time bin start time of 00:00 AM on January 1 and a time bin end time of 02:00 AM on January 1. The second time bin would have a time bin start time of 02:00 AM on January 1 and a time bin end time of 04:00 AM on January 1. This would continue until the 684th time bin, which would have a time bin start time of 10:00 PM on February 26, and a time bin end time of 00:00 AM on February 27. For the sake of clarity, it is assumed in the description herein that the time bin start time is an inclusive threshold (i.e., times including and after the threshold) and the time bin end time is an exclusive threshold (i.e., times up to but not including the threshold), but in other embodiments, other types of thresholds may be used (e.g., the time bin start time may be an exclusive threshold while the time bin end time may be an inclusive threshold, etc.).

At block 1018, the matrix management engine 916 retrieves data records for the data type from the trace data store 908 or the metrology data store 912 that are between the overall start time and the overall end time. At block 1020, the matrix management engine 916 determines a number of first dimension bins and a number of second dimension bins based on the retrieved data records. As discussed above with respect to FIG. 4, FIG. 5A and FIG. 5B, the values represented by the first dimension and the second dimension depend on the data type. For example, if the data type is trace data represented by time-series data records, the first dimension may represent elapsed times of time-value pairs, and the second dimension may represent values of time-value pairs. As another example, if the data type is metrology data, the first dimension may represent a horizontal location of a detected error and the second dimension may represent a vertical location of the detected error.

The number of first dimension bins and the number of second dimension bins may be determined using any suitable technique. As discussed above, many techniques for choosing a number of bins in a histogram are known, including but not limited to square-root choice (k=┌\sqrt{n}┐), Sturges's formula (k=┌log₂ n┐+1, which implicitly assumes an approximately normal distribution), or other techniques, wherein k is the number of bins and n is the number of data points in the sample. In some embodiments, the number of bins for the first dimension or the second dimension may be configured to provide a desired amount of resolution for the dimension, instead of by the number of data points. This may be appropriate for a first dimension that represents elapsed time, since the data points may be expected to be evenly distributed amongst the time dimension bins if the frequency of the generated data points remains consistent. In some embodiments, the number of bins on either dimension may be adjusted by the user.

The method 1000 then proceeds to a for-loop defined between a for-loop start block 1022 and for-loop end block 1042, wherein the matrix management engine 916 creates a matrix for each time bin. The matrix holds the totals for each of the data records that fall between the time bin start time and the time bin end time.

From for-loop start block 1022, the method 1000 proceeds to block 1024, where the matrix management engine 916 initializes a matrix having a matrix start time equal to the time bin start time, a matrix end time equal to the time bin end time, a first dimension based on the number of first dimension bins and a second dimension based on the number of second dimension bins. As described above, the intersection of a first dimension bin and a second dimension bin may be referred to as a cell of the matrix. In some embodiments, the first dimension may include threshold values defining the boundaries for each of the first dimension bins, and the second dimension may include threshold values defining the boundaries for each of the second dimension bins. In some embodiments, the threshold values for at least one of the first dimension or the second dimension may be implied through mathematical operations based on the number of dimension bins and the minimum/maximum values for the dimension.

At block 1026, the matrix management engine 916 determines a set of data records from the retrieved data records between the time bin start time and the time bin end time. The method 1000 then proceeds to a continuation terminal (“terminal B”).

From terminal B (FIG. 10C), the method 1000 proceeds to a for-loop defined between a for-loop start block 1028 and a for-loop end block 1038, wherein each data record of the set of data records from the retrieved data records between the time bin start time and the time bin end time is processed to add the data points of each data record to the matrix.

From for-loop start block 1028, the method 1000 proceeds to another for-loop defined between a for-loop start block 1030 and a for-loop end block 1036, wherein each data point within the data record is processed. From for-loop start block 1030, the method 1000 proceeds to block 1032, where the matrix management engine 916 determines a first dimension bin and a second dimension bin for the data point. In some embodiments, the matrix management engine 916 may compare the first dimension of the data point to the thresholds for the first dimension bins to determine the first dimension bin, and may compare the second dimension of the data point to the thresholds for the second dimension bins to determine the second dimension bin.

For example, for a time-value pair of a time-series data record, the matrix management engine 916 may compare the time of the time-value pair to thresholds of elapsed time bins to determine a matching elapsed time bin (the first dimension bin), and may compare the value of the time-value pair to thresholds of value bins to determine a matching value bin (the second dimension bin). As another example, for a data point of a metrology data record, the matrix management engine 916 may compare a horizontal location of the data point to thresholds of the first dimension bins to determine a matching first dimension bin, and may compare a vertical location of the data point to thresholds of the second dimension bins to determine a matching second dimension bin.

As noted with respect to block 1024, the use of thresholds to determine matching dimension bins is a non-limiting example only, and in some embodiments, other techniques may be used to determine the matching dimension bins for a given data point, such as dividing a value of the data point by the maximum value for the dimension and multiplying by the number of dimension bins for the dimension.

At block 1034, the matrix management engine 916 increments a count of a cell in the matrix associated with the first dimension bin and the second dimension bin. By doing so, the count of the cell eventually represents the number of data points within all of the data records of the time bin that fall within the combination of the first dimension bin and the second dimension bin.

The method 1000 then proceeds to for-loop end block 1036. If further data points remain to be processed in the data record, then the method 1000 returns to for-loop start block 1030 to process the next data point. Otherwise, the method 1000 proceeds from for-loop end block 1036 to for-loop end block 1038. At for-loop end block 1038, if further data records remain to be processed in the set of data records, then the method 1000 returns to for-loop start block 1028 to process the next data record. Otherwise, the method 1000 proceeds from for-loop end block 1038 to block 1040.

At block 1040, the matrix management engine 916 stores the matrix in a matrix data store 914 of the data management computing system 112. FIG. 5B, which was discussed in detail above, illustrates a non-limiting example of a result of the processing from block 1024 to block 1040 on time-series data records representing the first time series 202 and the second time series 204 of FIG. 2. The matrix of FIG. 5B has a matrix start time equal to a time bin start time of Dec. 18, 2024 at 00:00:00 AM and a matrix end time equal to a time bin end time of Dec. 19, 2024 at 23:59:59. Accordingly, both the first time series 202 (with a start time of Dec. 12, 2018 at 05:36:17) and the second time series 204 (with a start time of Dec. 19, 2024 at 13:16:00) would fall within this time bin and matrix, and would be determined to be between the time bin start time and the time bin end time at block 1026. The thresholds for the value bins are shown, the thresholds for every other elapsed time bin are shown (to avoid unnecessarily cluttering the drawing), and the counts for each of the non-zero cells are also illustrated. Since both the first time series 202 and the second time series 204 have time-value pairs with times within the first elapsed time bin (between 0:00 and 0:01) and values in the first value bin (between 0 and 1), the cell for the intersection of the first elapsed time bin and the first value bin has a count of 2; only the first time series 202 has a time-value pair with a time in the second elapsed time bin (0:01-0:02) and a value in the third value bin (between 2 and 3), so the cell for the intersection of the second elapsed time bin and the third value bin has a count of 1; and so on.

In some embodiments, the matrix management engine 916 may store the entire matrix in the matrix data store 914, similar to how it is illustrated in FIG. 5A and FIG. 5B. In some embodiments, the matrix management engine 916 may store a compressed version of the matrix in the matrix data store 914 (and/or may use compressed versions for other intermediate storage of the matrix). Any suitable compressed format may be used. In some embodiments, a compressed-sparse-column format may be used to store the matrix, which may be particularly efficient for combining matrices. A non-limiting example of a compressed-sparse-column format version of FIG. 5B would be:
VALUES=[2 1 1 1 1 1 1 1 1 2 1 1 1 1 1 1]
ROW_INDICES=[0 1 1 2 2 3 3 4 4 5 6 6 7 7 8 8]
COL_OFFSETS=[0 1 3 5 7 9 10 12 14 16]

The size of the entire matrix is N×M, with N being the number of first dimension bins and M being the number of second dimension bins. Accordingly, the computing resources used by storing the entire matrix is O(N*M). The size of the compressed-sparse-column format version, meanwhile, is (N+1)+(2*NZE), where NZE is the number of non-zero elements in the matrix. The computing resources used by storing the compressed-sparse-column version, therefore, is merely O(NZE). Since it is expected that most cells in the matrices will be zero, this representation should be particularly efficient for storage and combination of these matrices.

Returning to FIG. 10C, the method 1000 then proceeds to for-loop end block 1042. If further time bins remain to be processed, then the method 1000 returns from for-loop end block 1042 to for-loop start block 1022 via terminal C to process the next time bin. Otherwise, if all of the time bins have been processed, then the method 1000 proceeds to for-loop end block 1044.

At for-loop end block 1044, if further data types remain to be processed, then the method 1000 returns from for-loop end block 1044 to for-loop start block 1014 via terminal D to process the next data type. Otherwise, if all of the data types have been processed, then the method 1000 proceeds to an end block and terminates.

Upon completion, the method 1000 has created and stored a matrix that summarizes the data records for each time bin and for each data type. These matrices may then be used as the basis for efficiently generating and displaying heat maps by a heat map presentation computing system, as will be discussed in further detail below.

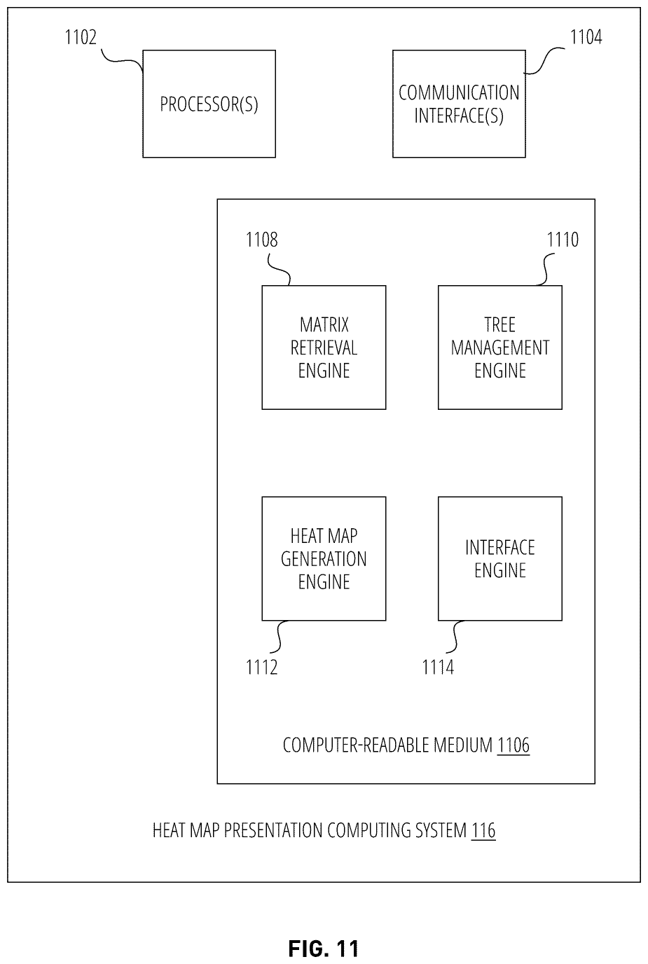

FIG. 11 is a block diagram that illustrates aspects of a non-limiting example embodiment of a heat map presentation computing system according to various aspects of the present disclosure. The illustrated heat map presentation computing system 116, which may be considered a browser computing system in some embodiments, may be implemented by any computing device or collection of computing devices, including but not limited to a desktop computing device, a laptop computing device, a mobile computing device, a server computing device, a computing device of a cloud computing system, and/or combinations thereof. The heat map presentation computing system 116 is configured to retrieve matrices from the data management computing system 112, and to use the retrieved matrices to generate heat maps representing the data records.

As shown, the heat map presentation computing system 116 includes one or more processors 1102, one or more communication interfaces 1104 and a computer-readable medium 1106.

In some embodiments, the processors 1102 may include any suitable type of general-purpose computer processor. In some embodiments, the processors 1102 may include one or more special-purpose computer processors or AI accelerators optimized for specific computing tasks, including but not limited to graphical processing units (GPUs), vision processing units (VPUs), and tensor processing units (TPUs).

In some embodiments, the communication interfaces 1104 include one or more hardware and or software interfaces suitable for providing communication links between components. The communication interfaces 1104 may support one or more wired communication technologies (including but not limited to Ethernet, Fire Wire, and USB), one or more wireless communication technologies (including but not limited to Wi-Fi, WiMAX, Bluetooth, 2G, 3G, 4G, 5G, and LTE), and/or combinations thereof.

As shown, the computer-readable medium 1106 has stored thereon logic that, in response to execution by the one or more processors 1102, cause the heat map presentation computing system 116 to provide a matrix retrieval engine 1108, a tree management engine 1110, a heat map generation engine 1112, and an interface engine 1114.

In some embodiments, the interface engine 1114 is configured to generate the heat map interface 402, to receive input from users via the heat map interface 402, and to present heat maps 404 via the heat map interface 402. In some embodiments, the matrix retrieval engine 1108 is configured to retrieve matrices from the data management computing system 112 of data types and from ranges requested via the heat map interface 402. In some embodiments, the tree management engine 1110 is configured to build trees from the retrieved matrices. In some embodiments, the heat map generation engine 1112 is configured to use the trees built by the tree management engine 1110 to efficiently perform the calculations for generating heat maps 404 for specific periods of time requested via the heat map interface 402.

Further description of the configuration of each of these components is provided below.

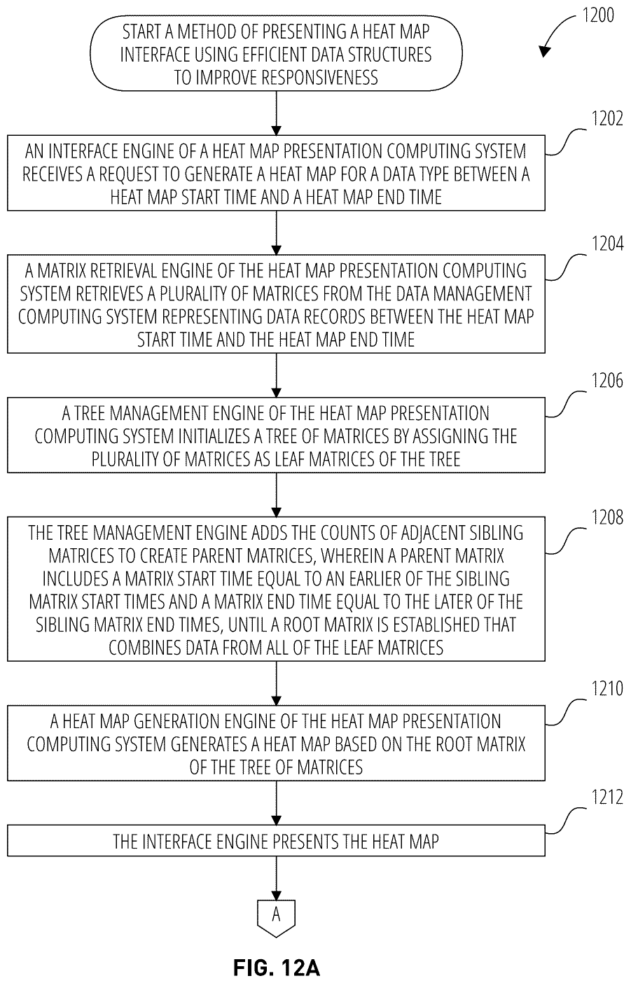

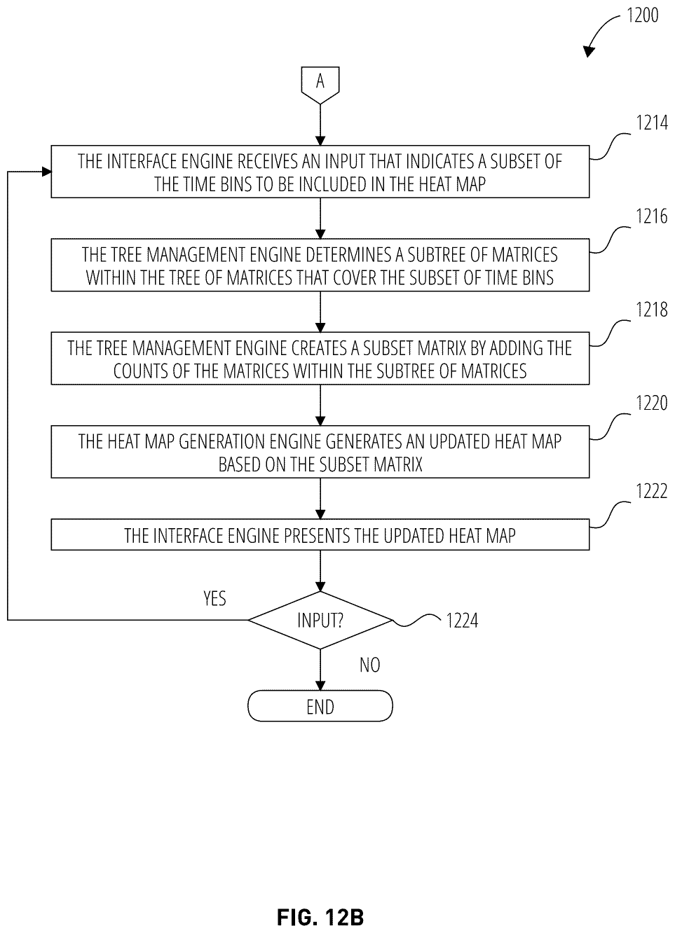

FIG. 12A-FIG. 12B are a flowchart that illustrates a non-limiting example embodiment of a method of presenting a heat map interface using efficient data structures to improve responsiveness, according to various aspects of the present disclosure. In the method 1200, matrices for time bins representing an overall period of time are obtained, and a tree of matrices summarizing the matrices is computed. The tree of matrices includes the obtained matrices as leaf matrices, and parent matrices that represent the combination of their children, such that a root matrix of the tree of matrices represents the combination of all of the leaf matrices. The tree is then used to rapidly generate updated heat maps when new periods of time within the overall period of time are selected for display by eliminating most of the computational work of combining the matrices themselves.

From a start block, the method 1200 proceeds to block 1202, where an interface engine 1114 of a heat map presentation computing system 116 receives a request to generate a heat map for a data type between a heat map start time and a heat map end time. In some embodiments, the interface engine 1114 may generate an interface such as the heat map interface 402 illustrated and described above, may receive the heat map start time and the heat map end time via the time selector interface element 406, and may receive the desired data type via the data type selector interface element 408. In some embodiments, additional filter information may be provided via the heat map interface 402.

At block 1204, a matrix retrieval engine 1108 of the heat map presentation computing system 116 retrieves a plurality of matrices from the data management computing system 112 representing data records between the heat map start time and the heat map end time. The plurality of matrices were previously created using a method such as method 1000 described above. In some embodiments, the plurality of matrices may have been previously generated by the method 1000 and stored in the matrix data store 914 until requested. In some embodiments, the plurality of matrices may have been generated by the method 1000 in response to receiving the request from the matrix retrieval engine 1108.

At block 1206, a tree management engine 1110 of the heat map presentation computing system 116 initializes a tree of matrices by assigning the plurality of matrices as leaf matrices of the tree. At block 1208, the tree management engine 1110 adds the counts of adjacent sibling matrices to create parent matrices, wherein a parent matrix includes a matrix start time equal to an earlier of the sibling matrix start times and a matrix end time equal to the later of the sibling matrix end times, until a root matrix is established that combines data from all of the leaf matrices.

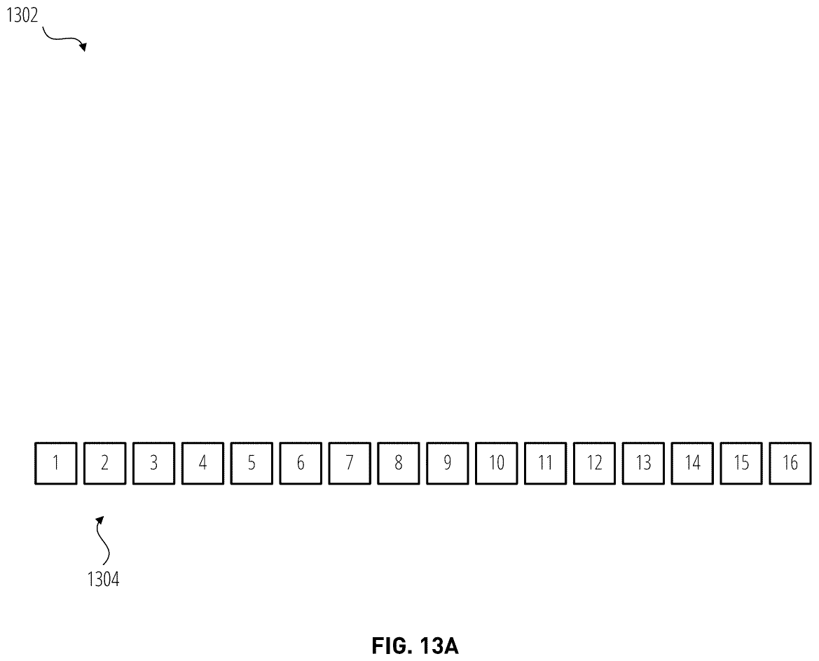

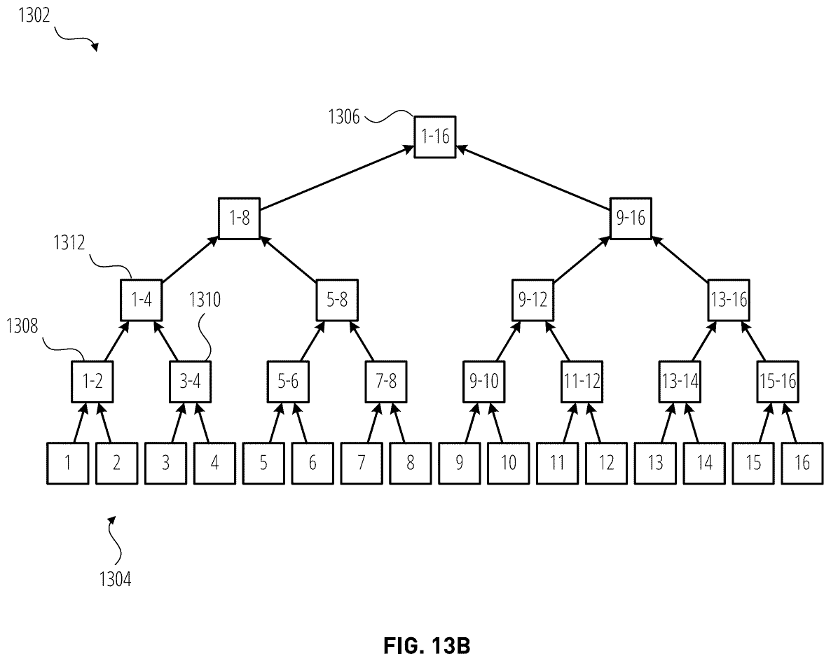

FIG. 13A and FIG. 13B illustrate a non-limiting example of the construction of a tree of matrices as described at block 1206 and block 1208. Let it be assumed that in block 1204, sixteen matrices were received from the data management computing system 112. In FIG. 13A, the sixteen matrices are illustrated as leaf matrices 1304 of the tree of matrices 1302. Sixteen leaf matrices 1304 are illustrated to improve the clarity of the drawing and the description, but it should be noted that the number of leaf matrices will typically match the number of time bins determined at block 1016 (e.g., a number of time bins between 600 and 1000, such as 800 time bins), and provides an amount of granularity at which the period of time of the heat map may be adjusted.

Each leaf matrix 1304 includes a matrix start time and a matrix end time, and are arranged in order such that the matrix start time of leaf matrix 1 coincides with the heat map start time, the matrix end time of leaf matrix 1 coincides with the matrix start time of leaf matrix 2, the matrix end time of leaf matrix 2 coincides with the matrix start time of leaf matrix 3, and so on until leaf matrix 16, whose matrix end time coincides with the heat map end time.

In FIG. 13B, the construction of the tree of matrices 1302 has been completed. The tree management engine 1110 added the counts of adjacent sibling matrices leaf matrix 1 and leaf matrix 2 to create a first parent matrix 1308. The first parent matrix 1308 has a matrix start time equal to the matrix start time of leaf matrix 1, a matrix end time equal to the matrix end time of leaf matrix 2, and cell values that represent the addition of leaf matrix 1 to leaf matrix 2. Similar operations were performed on leaf matrix 3 and leaf matrix 4 to create the second parent matrix 1310, as well as the other parent matrices of the leaf matrices 1304. Once this first level of parent matrices is created, the tree management engine 1110 proceeds to create a second level of parent matrices. A third parent matrix 1312 is created by combining first parent matrix 1308 and the second parent matrix 1310, which are adjacent sibling matrices of their level. The third parent matrix 1312 has a matrix start time equal to the matrix start time of leaf matrix 1, a matrix end time equal to the matrix end time of leaf matrix 4, and cell values that represent the addition of leaf matrices 1, 2, 3, and 4. These operations are repeated for each level until a root matrix 1306 is generated having a matrix start time that is equal to the matrix start time of leaf matrix 1, a matrix end time equal to the matrix end time of leaf matrix 16, and cell values that represent the addition of all of the leaf matrices 1-16 to each other.

While FIG. 13B illustrates a balanced binary tree, this should not be seen as limiting. In some embodiments, there may be more than two child matrices combined to create one or more parent matrices in the tree of matrices. In some embodiments, the tree of matrices may not be completely balanced, including but not limited to binary trees that do not include a number of leaf matrices that is a power of 2.

At block 1210, a heat map generation engine 1112 of the heat map presentation computing system 116 generates a heat map based on the root matrix of the tree of matrices. The heat map, such as the heat map 404 illustrated in FIG. 4, may be generated as described above, where zero-value cells of the root matrix are shown as black, and non-zero value cells of the root matrix are shown in a color specified by the color selector interface element 410, at a brightness determined based on the count in the cell and the setting of the density selector interface element 416. Similar to the heat map 404 illustrated in FIG. 4, the heat map generated for the root matrix 1306 presents all of the information from the heat map start time to the heat map end time.

At block 1212, the interface engine 1114 presents the heat map. The calculation of the tree of matrices takes slightly more computing resources than it would take to directly calculate the root matrix from the leaf matrices. However, this up-front investment of computing time greatly accelerates adjustments to the heat map interface 402, as will be described below. The method 1200 then proceeds to a continuation terminal (“terminal A”).

From terminal A (FIG. 12B), the method 1200 proceeds to block 1214, the interface engine 1114 receives an input that indicates a subset of the time bins to be included in the heat map. As illustrated in FIG. 8A and FIG. 8B, the subset of the time bins may be indicated by adjusting the time slider interface element 414. Each possible position for the time slider start element 418 and the time slider end element 420 corresponds to a matrix start time or matrix end time of a leaf matrix, such that moving the time slider start element 418 and/or the time slider end element 420 indicates which leaf matrices should be combined to create the heat map.

At block 1216, the tree management engine 1110 determines a subtree of matrices within the tree of matrices that cover the subset of time bins. Because the subset of time bins corresponds to a subset of the leaf matrices, the tree management engine 1110 may determine the subtree that covers all of the desired leaf matrices.

At block 1218, the tree management engine 1110 creates a subset matrix by adding the counts of the matrices within the subtree of matrices. Importantly, the tree management engine 1110 does not have to add the counts of all of the desired leaf matrices, since the parent matrices already include the sums of the counts of all of their child matrices. If an entire subtree of a given parent matrix is included in the desired leaf matrices, then the given parent matrix can be used instead of referencing the individual matrices of the subtree.

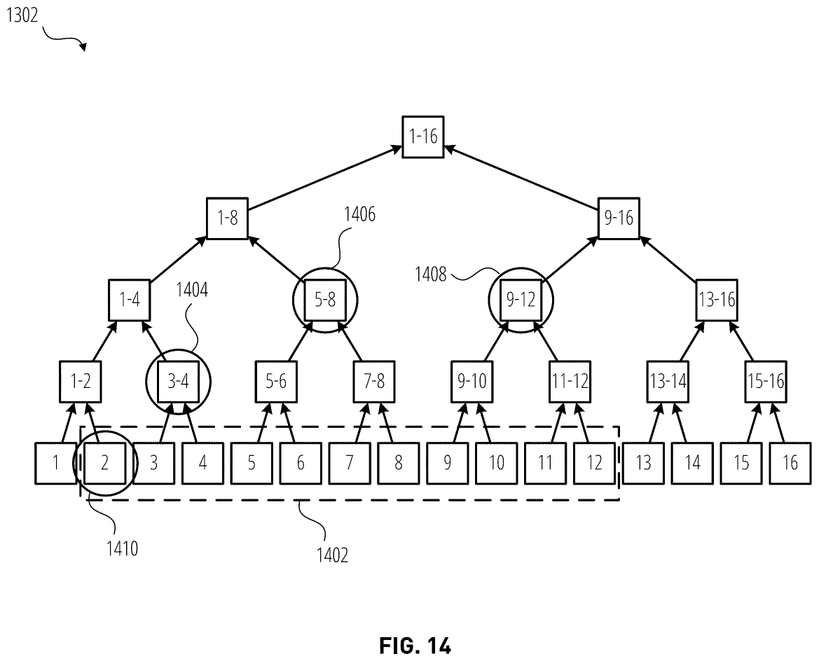

FIG. 14 illustrates an example of determining a subtree of matrices and adding the counts of the matrices within the subtree of matrices for the tree of matrices 1302 illustrated in FIG. 13A and FIG. 13B. In FIG. 14, the time bins associated with leaf matrix 2 through leaf matrix 12 are desired. Adding the subset leaf matrices 1402 directly to create the subset matrix would use 10 matrix additions. However, the subtree can be leveraged by using leaf matrix 2 1410, the parent matrix 1404 that includes the sum of leaf matrices 3-4, the parent matrix 1406 that includes the sum of leaf matrices 5-8, and the parent matrix 1408 that includes the sum of leaf matrices 9-12. Adding these matrices of the subtree merely uses 3 matrix additions but generates the same subset matrix as directly adding all of the subset leaf matrices 1402.

While the reduction from 10 matrix additions to 3 matrix additions is not large in absolute terms, it should be noted that in embodiments of the present disclosure, there will typically be many more than sixteen time bins/leaf matrices, and using this technique immensely reduces the amount of computational resources needed. For N time bins, the worst case amount of computation required to generate a subset matrix by simply adding the leaf matrices of the subset is O(N). By using the tree of matrices, however, the worst case amount of computation required to generate the subset matrix for a binary tree of matrices is reduced to O(logₓ N) matrix additions, with x being the degree of the tree (e.g., x=2 for a binary tree). With the example of 800 time bins and a binary tree, this reduces the worst case amount of matrix additions from 798 to about 16. This drastic reduction in the amount of computation utilized allows the heat map interface 402 to be responsive enough to update in real time in response to adjustment of the time slider interface element 414, even if the heat map presentation computing system 116 is implemented using relatively low-powered computing hardware, or components of the heat map presentation computing system 116 such as the heat map generation engine 1112 and/or the tree management engine 1110 are hosted within a web browser.

At block 1220, the heat map generation engine 1112 generates an updated heat map based on the subset matrix. The updated heat map is produced similarly to the original heat map, but using the subset matrix as the source of the counts for the cells instead of the root matrix.

At block 1222, the interface engine 1114 presents the updated heat map. The method 1200 then proceeds to decision block 1224, where a determination is made regarding whether further input is received by the interface engine 1114. If further input is received, then the result of decision block 1224 is YES, and the method 1200 returns to block 1214 to process the next input. Otherwise, if no further input is received, then the result of decision block 1224 is NO, and the method 1200 proceeds to an end block and terminates.

Though method 1000 and method 1200 describe certain tasks being split between the data management computing system 112 and the heat map presentation computing system 116, this description should not be seen as limiting, and in some embodiments, these tasks may be distributed differently. For example, in some embodiments, the data management computing system 112 and heat map presentation computing system 116 may be combined into a single computing system. As another example, in some embodiments, the data management computing system 112 may calculate the tree of matrices and transmit the entire tree of matrices to the heat map presentation computing system 116 instead of just the leaf matrices, to save computing resources at the heat map presentation computing system 116 at the cost of increased network utilization.

While illustrative embodiments have been illustrated and described, it will be appreciated that various changes can be made therein without departing from the spirit and scope of the invention.

### EXAMPLES

The following paragraphs describe a set of non-limiting example embodiments of the present disclosure.
Example 1: A computer-implemented method of presenting information from a plurality of data records, the method comprising: receiving, by a computing system, a plurality of matrices, wherein each matrix of the plurality of matrices is associated with a time bin indicating a start time and an end time for data within the matrix, wherein each matrix of the plurality of matrices includes a first dimension that represents a plurality of first dimension bins and a second dimension that represents a plurality of second dimension bins, and wherein each cell of each matrix of the plurality of matrices indicates a count of data records from the time bin of the matrix that have a value in an associated first dimension bin and an associated second dimension bin; creating, by the computing system, a tree of matrices, wherein the matrices of the plurality of matrices are leaf matrices of the tree and are ordered according to their associated time bins, and wherein creating the tree of matrices includes summing adjacent matrices to create parent matrices that represent multiple time bins, such that a root matrix of the tree of matrices includes information for all of the time bins; and presenting, by the computing system, a heat map based on the root matrix of the tree of matrices.
Example 2: The computer-implemented method of example 1, wherein the first dimension represents a plurality of elapsed time bins and the second dimension represents a plurality of value bins; and wherein each cell of each matrix of the plurality of matrices indicates a count of time-series data records collected during the time bin of the matrix that have a value in the associated value bin at an elapsed time in the associated elapsed time bin.
Example 3: The computer-implemented method of any one of examples 1-2, wherein the first dimension represents a plurality of horizontal location bins and the second dimension represents a plurality of vertical location bins; and wherein each cell of each matrix of the plurality of matrices indicates a count of metrology data records captured during the time bin of the matrix that indicate an error at a horizontal location in the horizontal location bin and at a vertical location in the vertical location bin.
Example 4: The computer-implemented method of any one of examples 1-3, wherein each matrix of the plurality of matrices is a sparse matrix in a compressed sparse column format.
Example 5: The computer-implemented method of any one of examples 1-4, wherein presenting the heat map based on the root matrix of the tree of matrices comprises: determining a maximum count of the counts in the cells of the root matrix; and for each cell in the root matrix, adjusting a brightness of a corresponding pixel in the heat map based on a comparison of the count of the cell to the maximum count.
Example 6: The computer-implemented method of example 5, wherein adjusting the brightness of the corresponding pixel in the heat map based on the comparison of the count of the cell to the maximum count includes raising a density value to a power associated with a user-adjustable contrast setting, wherein the density value is based on the comparison of the count of the cell to the maximum count.
Example 7: The computer-implemented method of any one of examples 1-6, further comprising: receiving, by the computing system, an input that indicates a subset of the time bins to be included in the heat map; determining, by the computing system, one or more matrices of the tree of matrices that cover the subset of the time bins; adding, by the computing system, the counts of the one or more matrices of the tree of matrices that cover the subset of the time bins to create a subset matrix; and presenting, by the computing system, an updated heat map based on the subset matrix.
Example 8: The computer-implemented method of example 7, wherein receiving the input that indicates a subset of the time bins to be included in the heat map includes receiving one of: an input that adjusts a start time indicated by a time slider interface element while leaving an end time indicated by the time slider interface element constant; an input that adjusts the end time indicated by the time slider interface element while leaving the start time indicated by the time slider interface element constant; or an input that adjusts both the start time and the end time indicated by the time slider interface element by matching amounts.
Example 9: The computer-implemented method of any one of examples 1-8, wherein the plurality of matrices is a first plurality of matrices, wherein the first plurality of matrices is associated with a first data category, wherein the heat map is a first heat map; and wherein the method further comprises: receiving, by the computing system, a second plurality of matrices associated with a second data category; and presenting, by the computing system, a second heat map based on the second plurality of matrices; wherein the second heat map is superimposed on the first heat map; wherein the first heat map uses a first color; and wherein the second heat map uses a second color.
Example 10: A computer-implemented method of presenting information from a plurality of data records collected between a start time and an end time, the method comprising: determining, by a computing system, a plurality of time bins based on the start time and the end time; for each time bin: initializing, by the computing system, a matrix to be associated with the time bin, wherein the matrix includes a first dimension that represents a plurality of first dimension bins and a second dimension that represents a plurality of second dimension bins, and wherein each cell of the matrix indicates a count of data records from the time bin of the matrix that have an value in an associated first dimension bin and an associated second dimension bin; determining, by the computing system, a set of data records of the plurality of data records that are associated with the time bin; for each data record in the set of data records: for each data point in the data record: determining, by the computing system, a first dimension bin and a second dimension bin for the data point; and incrementing, by the computing system, the count of the cell in the matrix associated with the first dimension bin and the second dimension bin; and transmitting, by the computing system, the matrices associated with the plurality of time bins to an interface for generating a heat map based on the matrices.
Example 11: The computer-implemented method of example 10, wherein the first dimension represents a plurality of elapsed time bins and the second dimension represents a plurality of value bins; and wherein each cell of each matrix of the plurality of matrices indicates a count of time-series data records captured during the time bin of the matrix that have a value in the associated value bin at an elapsed time in the associated elapsed time bin.
Example 12: The computer-implemented method of any one of examples 10-11, wherein the first dimension represents a plurality of horizontal location bins and a second dimension represents a plurality of vertical location bins; and wherein each cell of each matrix of the plurality of matrices indicates a count of metrology data records captured during the time bin of the matrix that indicate an error at a horizontal location in the horizontal location bin and at a vertical location in the vertical location bin.
Example 13: The computer-implemented method of any one of examples 10-12, wherein determining the plurality of time bins based on the start time and the end time includes: determining a period of time between the start time and the end time; and dividing the period of time based on a bucket size that provides a desired granularity for the period of time.
Example 14: The computer-implemented method of any one of examples 10-13, further comprising: retrieving, by the computing system, the plurality of data records by querying a data store for data records between the start time and the end time.
Example 15: The computer-implemented method of any one of examples 10-14, wherein the matrix is a sparse matrix in a compressed sparse column format.
Example 16: A non-transitory computer-readable medium having computer-executable instructions stored thereon that, in response to execution by one or more processors of a computing system, cause the computing system to perform a method as recited in an one of example 1 to example 9.
Example 17: A non-transitory computer-readable medium having computer-executable instructions stored thereon that, in response to execution by one or more processors of a computing system, cause the computing system to perform a method as recited in any one of example 10 to example 15.
Example 18: A computing system configured to perform a method as recited in any one of example 1 to example 9.
Example 19: A computing system configured to perform a method as recited in any one of example 10 to example 15.
Example 20: A system, comprising: a data store configured to store data records; a server computing system; and a browser computing system; wherein the server computing system is configured to: receive a query from the browser computing system for information from data records between a start time and an end time; retrieve the data records from the data store; generate a plurality of matrices representing the information from the data records, wherein each matrix of the plurality of matrices is associated with a time bin; and transmit the plurality of matrices to the browser computing system; and wherein the browser computing system is configured to: generate a tree of matrices wherein parent matrices of the tree combine values from the matrices of the plurality of matrices; and present a heat map using the tree.
Example 21: The system of example 20, further comprising at least one sensor device configured to: collect data related to a manufacturing process; and store the data as a data record in the data store.
Example 22: The system of example 21, wherein the data includes a plurality of time-series data records.
Example 23: The system of any one of examples 21-22, wherein the data includes a plurality of metrology data records.
Example 24: The system any one of examples 21-23, wherein the manufacturing process is a semiconductor manufacturing process.
Example 25: The system of any one of examples 20-24, wherein each matrix in the plurality of matrices and the tree of matrices is a sparse matrix in a compressed sparse column format.
Example 26: The system of any one of examples 20-25, wherein the plurality of matrices are ordered according to their associated time bins, and wherein generating the tree of matrices includes summing adjacent matrices to create parent matrices that represent multiple time bins, such that a root matrix of the tree of matrices includes information for all of the time bins.
Example 27: The system of any one of examples 20-26, wherein presenting the heat map using the tree includes: determining a maximum count of the counts in the cells of a root matrix of the tree; and for each cell in the root matrix, adjusting a brightness of a corresponding pixel in the heat map based on a comparison of the count of the cell to the maximum count.
Example 28: The system of example 27, wherein adjusting the brightness of the corresponding pixel in the heat map based on a comparison of the count of the cell to the maximum count includes raising a density value to a power associated with a user-adjustable contrast setting, wherein the density value is based on the comparison of the count of the cell to the maximum count.
Example 29: The system of any one of examples 20-28, wherein the browser computing system is further configured to: receive, by the browser computing system, an input that indicates a subset of the time bins to be included in the heat map; determine, by the browser computing system, one or more matrices of the tree of matrices that cover the subset of the time bins; add, by the browser computing system, the counts of the one or more matrices of the tree of matrices that cover the subset of the time bins to create a subset matrix; and present, by the browser computing system, an updated heat map based on the subset matrix.
Example 30: The system of example 29, wherein receiving the input that indicates the subset of the time bins to be included in the heat map includes receiving one of: an input that adjusts a start time indicated by a time slider interface element while leaving an end time indicated by the time slider interface element constant; an input that adjusts the end time indicated by the time slider interface element while leaving the start time indicated by the time slider interface element constant; or an input that adjusts both the start time and the end time indicated by the time slider interface element by matching amounts.
Example 31: The system of any one of examples 20-30, wherein generating the plurality of matrices representing the information from the data records includes: determining, by the server computing system, a plurality of time bins based on the start time and the end time; for each time bin: initializing, by the server computing system, a matrix to be associated with the time bin, wherein the matrix includes a first dimension that represents a plurality of first dimension bins and a second dimension that represents a plurality of second dimension bins, and wherein each cell of the matrix indicates a count of data records from the time bin of the matrix that have a value in an associated first dimension bin and an associated second dimension bin; determining, by the server computing system, a set of data records of the plurality of data records that are associated with the time bin; for each data record in the set of data records: for each data point in the data record: determining, by the server computing system, a first dimension bin and a second dimension bin for the data point; and incrementing, by the server computing system, the count of the cell in the matrix associated with the first dimension bin and the second dimension bin.
Example 32: The system of example 31, wherein determining the plurality of time bins based on the start time and the end time includes: determining a period of time between the start time and the end time; and dividing the period of time based on a bucket size that provides a desired granularity for the period of time.

1. A computer-implemented method of presenting information from a plurality of data records, the method comprising:
receiving, by a computing system, a plurality of matrices,
wherein each matrix of the plurality of matrices is associated with a time bin indicating a start time and an end time for data within the matrix,
wherein each matrix of the plurality of matrices includes a first dimension that represents a plurality of first dimension bins and a second dimension that represents a plurality of second dimension bins, and
wherein each cell of each matrix of the plurality of matrices indicates a count of data records from the time bin of the matrix that have a value in an associated first dimension bin and an associated second dimension bin;
creating, by the computing system, a tree of matrices, wherein the matrices of the plurality of matrices are leaf matrices of the tree and are ordered according to their associated time bins, and wherein creating the tree of matrices includes summing adjacent matrices to create parent matrices that represent multiple time bins, such that a root matrix of the tree of matrices includes information for all of the time bins; and
presenting, by the computing system, a heat map based on the root matrix of the tree of matrices.

2. The computer-implemented method of claim 1, wherein the first dimension represents a plurality of elapsed time bins and the second dimension represents a plurality of value bins, and wherein each cell of each matrix of the plurality of matrices indicates a count of time-series data records collected during the time bin of the matrix that have a value in the associated value bin at an elapsed time in the associated elapsed time bin; or
wherein the first dimension represents a plurality of horizontal location bins and the second dimension represents a plurality of vertical location bins, and wherein each cell of each matrix of the plurality of matrices indicates a count of metrology data records captured during the time bin of the matrix that indicate an error at a horizontal location in the horizontal location bin and at a vertical location in the vertical location bin.

3. (canceled)

4. The computer-implemented method of claim 1, wherein each matrix of the plurality of matrices is a sparse matrix in a compressed sparse column format.

5. The computer-implemented method of claim 1, wherein presenting the heat map based on the root matrix of the tree of matrices comprises:
determining a maximum count of the counts in the cells of the root matrix; and
for each cell in the root matrix, adjusting a brightness of a corresponding pixel in the heat map based on a comparison of the count of the cell to the maximum count.

6. The computer-implemented method of claim 5, wherein adjusting the brightness of the corresponding pixel in the heat map based on the comparison of the count of the cell to the maximum count includes raising a density value to a power associated with a user-adjustable contrast setting, wherein the density value is based on the comparison of the count of the cell to the maximum count.

7. The computer-implemented method of claim 1, further comprising:
receiving, by the computing system, an input that indicates a subset of the time bins to be included in the heat map;
determining, by the computing system, one or more matrices of the tree of matrices that cover the subset of the time bins;
adding, by the computing system, the counts of the one or more matrices of the tree of matrices that cover the subset of the time bins to create a subset matrix; and
presenting, by the computing system, an updated heat map based on the subset matrix.

8. (canceled)

9. The computer-implemented method of claim 1, wherein the plurality of matrices is a first plurality of matrices, wherein the first plurality of matrices is associated with a first data category, wherein the heat map is a first heat map; and wherein the method further comprises:
receiving, by the computing system, a second plurality of matrices associated with a second data category; and
presenting, by the computing system, a second heat map based on the second plurality of matrices;
wherein the second heat map is superimposed on the first heat map;
wherein the first heat map uses a first color; and
wherein the second heat map uses a second color.

10. A computer-implemented method of presenting information from a plurality of data records collected between a start time and an end time, the method comprising:
determining, by a computing system, a plurality of time bins based on the start time and the end time;
for each time bin:
initializing, by the computing system, a matrix to be associated with the time bin, wherein the matrix includes a first dimension that represents a plurality of first dimension bins and a second dimension that represents a plurality of second dimension bins, and wherein each cell of the matrix indicates a count of data records from the time bin of the matrix that have an value in an associated first dimension bin and an associated second dimension bin;
determining, by the computing system, a set of data records of the plurality of data records that are associated with the time bin;
for each data record in the set of data records:
for each data point in the data record:
determining, by the computing system, a first dimension bin and a second dimension bin for the data point; and
incrementing, by the computing system, the count of the cell in the matrix associated with the first dimension bin and the second dimension bin; and
transmitting, by the computing system, the matrices associated with the plurality of time bins to an interface for generating a heat map based on the matrices.

11. The computer-implemented method of claim 10, wherein the first dimension represents a plurality of elapsed time bins and the second dimension represents a plurality of value bins, and wherein each cell of each matrix of the plurality of matrices indicates a count of time-series data records captured during the time bin of the matrix that have a value in the associated value bin at an elapsed time in the associated elapsed time bin; or
wherein the first dimension represents a plurality of horizontal location bins and a second dimension represents a plurality of vertical location bins, and wherein each cell of each matrix of the plurality of matrices indicates a count of metrology data records captured during the time bin of the matrix that indicate an error at a horizontal location in the horizontal location bin and at a vertical location in the vertical location bin.

12. (canceled)

13. The computer-implemented method of claim 10, wherein determining the plurality of time bins based on the start time and the end time includes:
determining a period of time between the start time and the end time; and
dividing the period of time based on a bucket size that provides a desired granularity for the period of time.

14-19. (canceled)

20. A system, comprising:
a data store configured to store data records;
a server computing system; and
a browser computing system;
wherein the server computing system is configured to:
receive a query from the browser computing system for information from data records between a start time and an end time;
retrieve the data records from the data store;
generate a plurality of matrices representing the information from the data records, wherein each matrix of the plurality of matrices is associated with a time bin; and
transmit the plurality of matrices to the browser computing system; and
wherein the browser computing system is configured to:
generate a tree of matrices wherein parent matrices of the tree combine values from the matrices of the plurality of matrices; and
present a heat map using the tree.

21. The system of claim 20, further comprising at least one sensor device configured to:
collect data related to a manufacturing process; and
store the data as a data record in the data store.

22. The system of claim 21, wherein the data includes at least one of a plurality of time-series data records or a plurality of metrology data records.

23. (canceled)

24. The system of claim 21, wherein the manufacturing process is a semiconductor manufacturing process.

25. The system of claim 20, wherein each matrix in the plurality of matrices and the tree of matrices is a sparse matrix in a compressed sparse column format.

26. The system of claim 20, wherein the plurality of matrices are ordered according to their associated time bins, and wherein generating the tree of matrices includes summing adjacent matrices to create parent matrices that represent multiple time bins, such that a root matrix of the tree of matrices includes information for all of the time bins.

27. The system of claim 20, wherein presenting the heat map using the tree includes:
determining a maximum count of the counts in the cells of a root matrix of the tree; and
for each cell in the root matrix, adjusting a brightness of a corresponding pixel in the heat map based on a comparison of the count of the cell to the maximum count.

28. (canceled)

29. The system of claim 20, wherein the browser computing system is further configured to:
receive, by the browser computing system, an input that indicates a subset of the time bins to be included in the heat map;
determine, by the browser computing system, one or more matrices of the tree of matrices that cover the subset of the time bins;
add, by the browser computing system, the counts of the one or more matrices of the tree of matrices that cover the subset of the time bins to create a subset matrix; and
present, by the browser computing system, an updated heat map based on the subset matrix.

30. The system of claim 29, wherein receiving the input that indicates the subset of the time bins to be included in the heat map includes receiving one of:
an input that adjusts a start time indicated by a time slider interface element while leaving an end time indicated by the time slider interface element constant;
an input that adjusts the end time indicated by the time slider interface element while leaving the start time indicated by the time slider interface element constant; or
an input that adjusts both the start time and the end time indicated by the time slider interface element by matching amounts.

31. The system of claim 20, wherein generating the plurality of matrices representing the information from the data records includes:
determining, by the server computing system, a plurality of time bins based on the start time and the end time;
for each time bin:
initializing, by the server computing system, a matrix to be associated with the time bin, wherein the matrix includes a first dimension that represents a plurality of first dimension bins and a second dimension that represents a plurality of second dimension bins, and wherein each cell of the matrix indicates a count of data records from the time bin of the matrix that have a value in an associated first dimension bin and an associated second dimension bin;
determining, by the server computing system, a set of data records of the plurality of data records that are associated with the time bin;
for each data record in the set of data records:
for each data point in the data record:
determining, by the server computing system, a first dimension bin and a second dimension bin for the data point; and
incrementing, by the server computing system, the count of the cell in the matrix associated with the first dimension bin and the second dimension bin.

32. (canceled)
